(19) United States
(12) Patent Application Publication
(10) Pub. No.: US 2025/0119851 A1
(43) Pub. Date: Apr. 10, 2025

(54) TIME SYNCHRONIZATION FAILURE INDICATIONS

(71) Applicant: QUALCOMM INCORPORATED, San Diego, CA (US)

(72) Inventors: Sebastian SPEICHER, Wallisellen (CH); Haris ZISIMOPOULOS, London (GB)

(21) Appl. No.: 18/833,297

(22) PCT Filed: Oct. 6, 2022
(86) PCT No.: PCT/US2022/077684

§ 371 Date: Jul. 25, 2024

(30) Foreign Application Priority Data
Jan. 27, 2022 (GR) 20220100074

(51) Int. Cl. H04W 56/00

(52) U.S. Cl. CPC H04W 56/001

(57) ABSTRACT

Various aspects of the present disclosure generally relate to wireless communication. In some aspects, a user equipment (UE) may receive, from a radio access network node, an indication that a time synchronization change has been detected. Accordingly, the UE may adjust a clock associated with the UE based at least in part on the indication. Numerous other aspects are described.

### CROSS-REFERENCE TO RELATED APPLICATION

This patent application claims priority to Greek Patent Application No. 20220100074, filed on Jan. 27, 2022, entitled “TIME SYNCHRONIZATION FAILURE INDICATIONS,” which is hereby expressly incorporated by reference herein.

### FIELD OF THE DISCLOSURE

Aspects of the present disclosure generally relate to wireless communication and to techniques and apparatuses for indicating time synchronization changes.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more base stations that support communication for a user equipment (UE) or multiple UEs. A UE may communicate with a base station via downlink communications and uplink communications. “Downlink” (or “DL”) refers to a communication link from the base station to the UE, and “uplink” (or “UL”) refers to a communication link from the UE to the base station.

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

Some aspects described herein relate to a method of wireless communication performed by a user equipment (UE). The method may include receiving, from a radio access network (RAN) node, an indication that a time synchronization change has been detected. The method may further include adjusting a clock associated with the UE based at least in part on the indication.

Some aspects described herein relate to an apparatus for wireless communication at a UE. The apparatus may include a memory and one or more processors coupled to the memory. The one or more processors may be configured to receive, from a RAN node, an indication that a time synchronization change has been detected. The one or more processors may be further configured to adjust a clock associated with the UE based at least in part on the indication.

Some aspects described herein relate to a non-transitory computer-readable medium that stores a set of instructions for wireless communication by a UE. The set of instructions, when executed by one or more processors of the UE, may cause the UE to receive, from a RAN node, an indication that a time synchronization change has been detected. The set of instructions, when executed by one or more processors of the UE, may further cause the UE to adjust a clock associated with the UE based at least in part on the indication.

Some aspects described herein relate to an apparatus for wireless communication. The apparatus may include means for receiving, from a RAN node, an indication that a time synchronization change has been detected. The apparatus may further include means for adjusting a clock associated with the apparatus based at least in part on the indication.

Some aspects described herein relate to a method of wireless communication performed by a RAN node. The method may include detecting a time synchronization change at the RAN node. The method may further include transmitting an indication, for an access stratum, that the time synchronization change has been detected.

Some aspects described herein relate to an apparatus for wireless communication at a RAN node. The apparatus may include a memory and one or more processors coupled to the memory. The one or more processors may be configured to detect a time synchronization change at the RAN node. The one or more processors may be further configured to transmit an indication, for an access stratum, that the time synchronization change has been detected.

Some aspects described herein relate to a non-transitory computer-readable medium that stores a set of instructions for wireless communication by a RAN node. The set of instructions, when executed by one or more processors of the RAN node, may cause the RAN node to detect a time synchronization change at the RAN node. The set of instructions, when executed by one or more processors of the RAN node, may further cause the RAN node to transmit an indication, for an access stratum, that the time synchronization change has been detected.

Some aspects described herein relate to an apparatus for wireless communication. The apparatus may include means for detecting a time synchronization change at the apparatus. The apparatus may further include means for transmitting an indication, for an access stratum, that the time synchronization change has been detected.

Some aspects described herein relate to a method of wireless communication performed by a time synchronization function node. The method may include receiving an indication that a time synchronization change has been detected. The method may further include transmitting an indication of the time synchronization change to an application function node.

Some aspects described herein relate to an apparatus for wireless communication at a time synchronization function node. The apparatus may include a memory and one or more processors coupled to the memory. The one or more processors may be configured to receive an indication that a time synchronization change has been detected. The one or more processors may be further configured to transmit an indication of the time synchronization change to an application function node.

Some aspects described herein relate to a non-transitory computer-readable medium that stores a set of instructions for wireless communication by a time synchronization function node. The set of instructions, when executed by one or more processors of the time synchronization function node, may cause the time synchronization function node to receive an indication that a time synchronization change has been detected. The set of instructions, when executed by one or more processors of the time synchronization function node, may further cause the time synchronization function node to transmit an indication of the time synchronization change to an application function node.

Some aspects described herein relate to an apparatus for wireless communication. The apparatus may include means for receiving an indication that a time synchronization change has been detected. The method may further include means for transmitting an indication of the time synchronization change to an application function node.

Some aspects described herein relate to a method of wireless communication performed by a user plane function node. The method may include detecting a time synchronization change. The method may further include transmitting an indication of the time synchronization change in a precision time protocol (PTP) message.

Some aspects described herein relate to an apparatus for wireless communication at a user plane function node. The apparatus may include a memory and one or more processors coupled to the memory. The one or more processors may be configured to detect a time synchronization change. The one or more processors may be further configured to transmit an indication of the time synchronization change in a PTP message.

Some aspects described herein relate to a non-transitory computer-readable medium that stores a set of instructions for wireless communication by a user plane function node. The set of instructions, when executed by one or more processors of the user plane function node, may cause the user plane function node to detect a time synchronization change. The set of instructions, when executed by one or more processors of the user plane function node, may further cause the user plane function node to transmit an indication of the time synchronization change in a PTP message.

Some aspects described herein relate to an apparatus for wireless communication. The apparatus may include means for detecting a time synchronization change. The apparatus may further include means for transmitting an indication of the time synchronization change in a PTP message.

Aspects generally include a method, apparatus, system, computer program product, non-transitory computer-readable medium, user equipment, base station, wireless communication device, and/or processing system as substantially described herein with reference to and as illustrated by the drawings, specification, and appendix.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a base station in communication with a user equipment (UE) in a wireless network, in accordance with the present disclosure.

FIG. 3A is a diagram illustrating an example of core network architecture, in accordance with the present disclosure.

FIG. 3B is a diagram illustrating another example of core network architecture, in accordance with the present disclosure.

FIG. 4 is a diagram illustrating an example associated with indicating time synchronization changes using UEs and a non-access stratum, in accordance with the present disclosure.

FIGS. 5A and 5B are a diagram illustrating an example associated with indicating time synchronization changes using UEs and a management function node, in accordance with the present disclosure.

FIG. 6 is a diagram illustrating an example associated with indicating time synchronization changes using a precision time protocol (PTP) and a non-access stratum, in accordance with the present disclosure.

FIGS. 7A and 7B are diagrams illustrating an example associated with indicating time synchronization changes using a PTP and a management function node, in accordance with the present disclosure.

FIGS. 8, 9, 10, and 11 are diagrams illustrating example processes associated with indicating time synchronization changes, in accordance with the present disclosure.

FIGS. 12, 13, and 14 are diagrams of example apparatuses for wireless communication, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

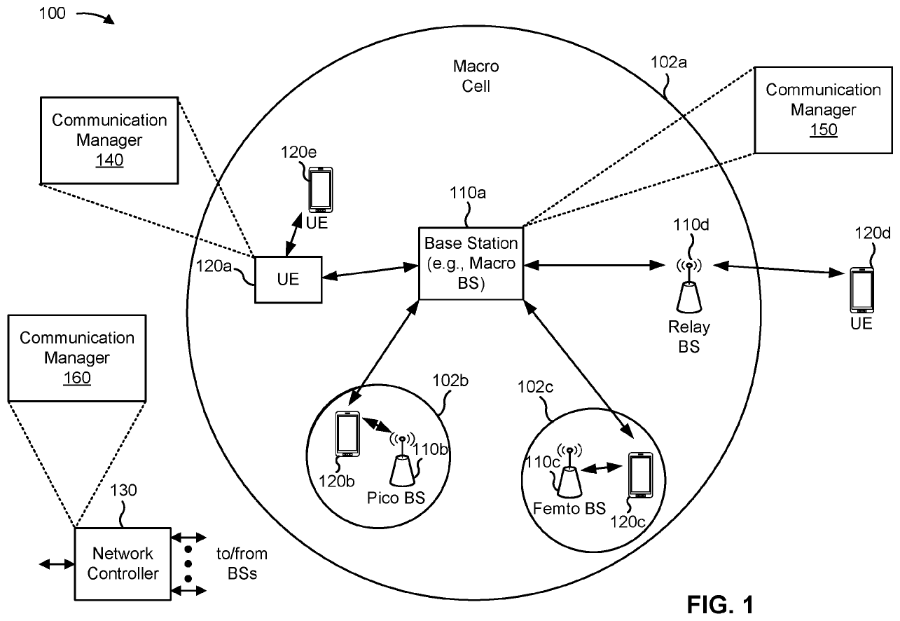

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more base stations 110 (shown as a BS 110a, a BS 110b, a BS 110c, and a BS 110d), a user equipment (UE) 120 or multiple UEs 120 (shown as a UE 120a, a UE 120b, a UE 120c, a UE 120d, and a UE 120e), and/or other network entities. A base station 110 is an entity that communicates with UEs 120. A base station 110 (sometimes referred to as a BS) may include, for example, an NR base station, an LTE base station, a Node B, an eNB (e.g., in 4G), a gNB (e.g., in 5G), an access point, and/or a transmission reception point (TRP). Each base station 110 may provide communication coverage for a particular geographic area. In the Third Generation Partnership Project (3GPP), the term “cell” can refer to a coverage area of a base station 110 and/or a base station subsystem serving this coverage area, depending on the context in which the term is used.

A base station 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscription. A femto cell may cover a relatively small geographic area (e.g., a home) and may allow restricted access by UEs 120 having association with the femto cell (e.g., UEs 120 in a closed subscriber group (CSG)). A base station 110 for a macro cell may be referred to as a macro base station. A base station 110 for a pico cell may be referred to as a pico base station. A base station 110 for a femto cell may be referred to as a femto base station or an in-home base station. In the example shown in FIG. 1, the BS 110a may be a macro base station for a macro cell 102a, the BS 110b may be a pico base station for a pico cell 102b, and the BS 110c may be a femto base station for a femto cell 102c. A base station may support one or multiple (e.g., three) cells.

In some aspects, the term “base station” (e.g., the base station 110) or “network entity” may refer to an aggregated base station, a disaggregated base station, an integrated access and backhaul (IAB) node, a relay node, and/or one or more components thereof. For example, in some aspects, “base station” or “network entity” may refer to a central unit (CU), a distributed unit (DU), a radio unit (RU), a Near-Real Time (Near-RT) RAN Intelligent Controller (RIC), or a Non-Real Time (Non-RT) RIC, or a combination thereof. In some aspects, the term “base station” or “network entity” may refer to one device configured to perform one or more functions, such as those described herein in connection with the base station 110. In some aspects, the term “base station” or “network entity” may refer to a plurality of devices configured to perform the one or more functions. For example, in some distributed systems, each of a number of different devices (which may be located in the same geographic location or in different geographic locations) may be configured to perform at least a portion of a function, or to duplicate performance of at least a portion of the function, and the term “base station” or “network entity” may refer to any one or more of those different devices. In some aspects, the term “base station” or “network entity” may refer to one or more virtual base stations and/or one or more virtual base station functions. For example, in some aspects, two or more base station functions may be instantiated on a single device. In some aspects, the term “base station” or “network entity” may refer to one of the base station functions and not another. In this way, a single device may include more than one base station.

In some examples, a cell may not necessarily be stationary, and the geographic area of the cell may move according to the location of a base station 110 that is mobile (e.g., a mobile base station). In some examples, the base stations 110 may be interconnected to one another and/or to one or more other base stations 110 or network nodes (not shown) in the wireless network 100 through various types of backhaul interfaces, such as a direct physical connection or a virtual network, using any suitable transport network.

The wireless network 100 may include one or more relay stations. A relay station is an entity that can receive a transmission of data from an upstream station (e.g., a base station 110 or a UE 120) and send a transmission of the data to a downstream station (e.g., a UE 120 or a base station 110). A relay station may be a UE 120 that can relay transmissions for other UEs 120. In the example shown in FIG. 1, the BS 110d (e.g., a relay base station) may communicate with the BS 110a (e.g., a macro base station) and the UE 120d in order to facilitate communication between the BS 110a and the UE 120d. A base station 110 that relays communications may be referred to as a relay station, a relay base station, a relay, or the like.

The wireless network 100 may be a heterogeneous network that includes base stations 110 of different types, such as macro base stations, pico base stations, femto base stations, relay base stations, or the like. These different types of base stations 110 may have different transmit power levels, different coverage areas, and/or different impacts on interference in the wireless network 100. For example, macro base stations may have a high transmit power level (e.g., 5 to 40 watts) whereas pico base stations, femto base stations, and relay base stations may have lower transmit power levels (e.g., 0.1 to 2 watts).

A network controller 130 may couple to or communicate with a set of base stations 110 and may provide coordination and control for these base stations 110. The network controller 130 may communicate with the base stations 110 via a backhaul communication link. The base stations 110 may communicate with one another directly or indirectly via a wireless or wireline backhaul communication link.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, and/or any other suitable device that is configured to communicate via a wireless medium.

Some UEs 120 may be considered machine-type communication (MTC) or evolved or enhanced machine-type communication (eMTC) UEs. An MTC UE and/or an eMTC UE may include, for example, a robot, a drone, a remote device, a sensor, a meter, a monitor, and/or a location tag, that may communicate with a base station, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a base station 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the base station 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHz) and FR2 (24.25 GHz-52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHz, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, the UE 120 may include a communication manager 140. As described in more detail elsewhere herein, the communication manager 140 may receive, from a radio access network (RAN) node (e.g., the base station 110), an indication that a time synchronization change has been detected and adjust a clock associated with the UE 120 based at least in part on the indication. Additionally, or alternatively, the communication manager 140 may perform one or more other operations described herein.

In some aspects, a RAN node (e.g., the base station 110) may include a communication manager 150. As described in more detail elsewhere herein, the communication manager 150 may detect a time synchronization change at the RAN node and transmit an indication, for an access stratum, that the time synchronization change has been detected. Additionally, or alternatively, the communication manager 150 may perform one or more other operations described herein.

In some aspects, the network controller 130 may include a time synchronization function node and a communication manager 160. Accordingly, as described in more detail elsewhere herein, the communication manager 160 may receive an indication that a time synchronization change has been detected and transmit an indication of the time synchronization change to an application function node (e.g., implemented on a different portion of the network controller 130 and/or another portion of a core network). Additionally, or alternatively, the network controller 130 may include a user plane function node. Accordingly, as described in more detail elsewhere herein, the communication manager 160 may detect a time synchronization change and transmit an indication of the time synchronization change in a precision time protocol (PTP) message. Additionally, or alternatively, the communication manager 160 may perform one or more other operations described herein

As indicated above, FIG. 1 is provided as an example. Other examples may differ from what is described with regard to FIG. 1.

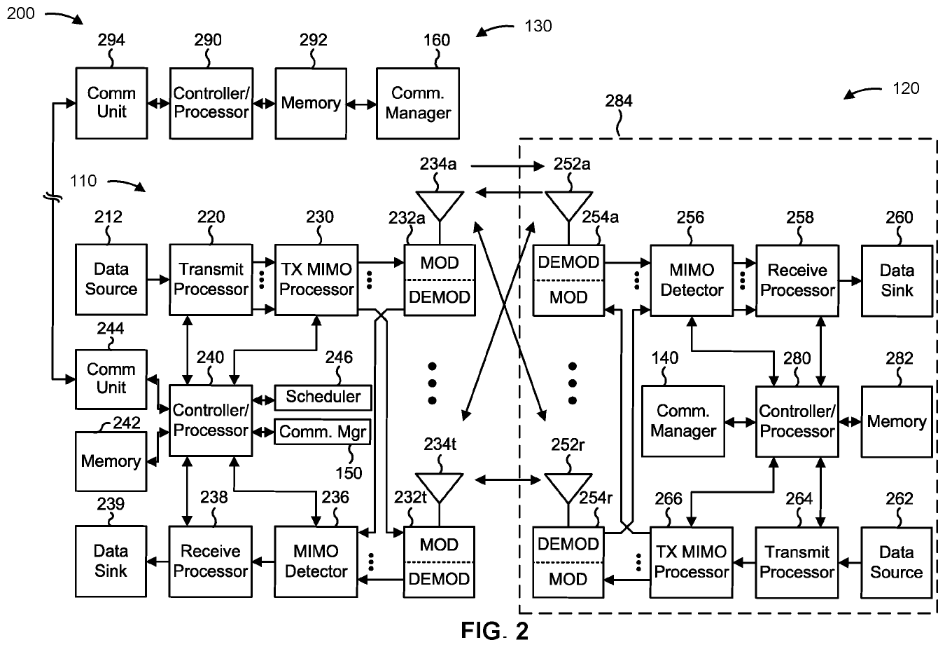

FIG. 2 is a diagram illustrating an example 200 of a base station 110 in communication with a UE 120 in a wireless network 100, in accordance with the present disclosure. The base station 110 may be equipped with a set of antennas 234a through 234t, such as T antennas (T≥1). The UE 120 may be equipped with a set of antennas 252a through 252r, such as R antennas (R≥1).

At the base station 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The base station 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., Tmodems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the base station 110 and/or other base stations 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the base station 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

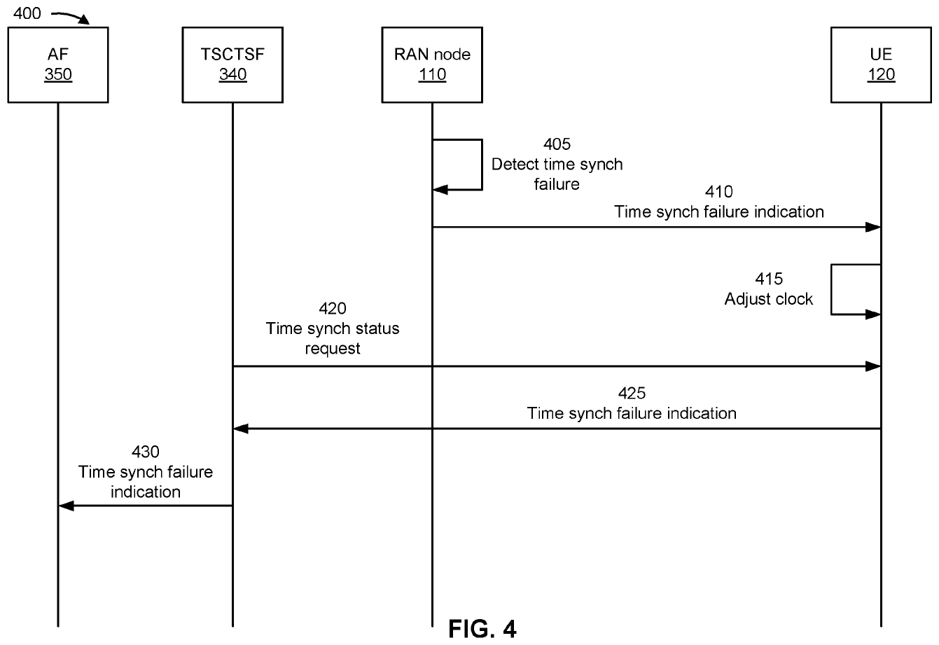

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the base station 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 4-14).

At the base station 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The base station 110 may include a communication unit 244 and may communicate with the network controller 130 via the communication unit 244. The base station 110 may include a scheduler 246 to schedule one or more UEs 120 for downlink and/or uplink communications. In some examples, the modem 232 of the base station 110 may include a modulator and a demodulator. In some examples, the base station 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 4-14).

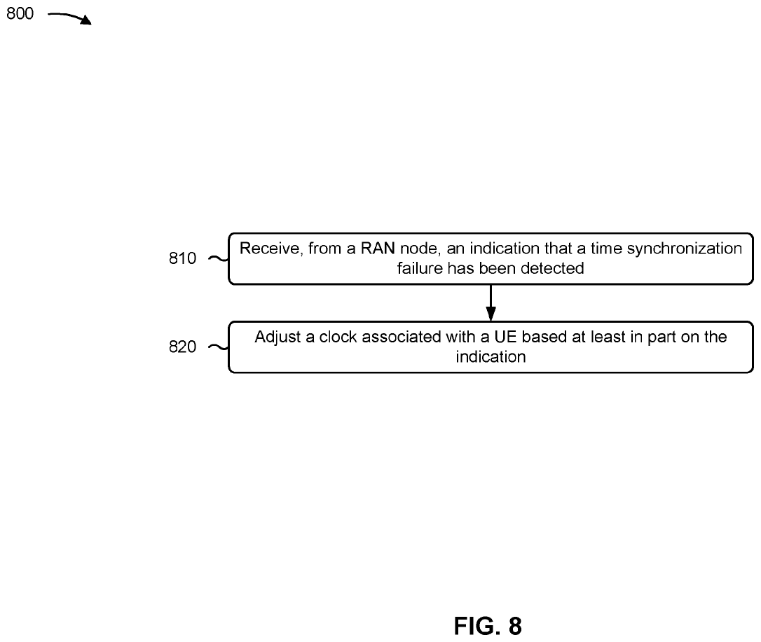

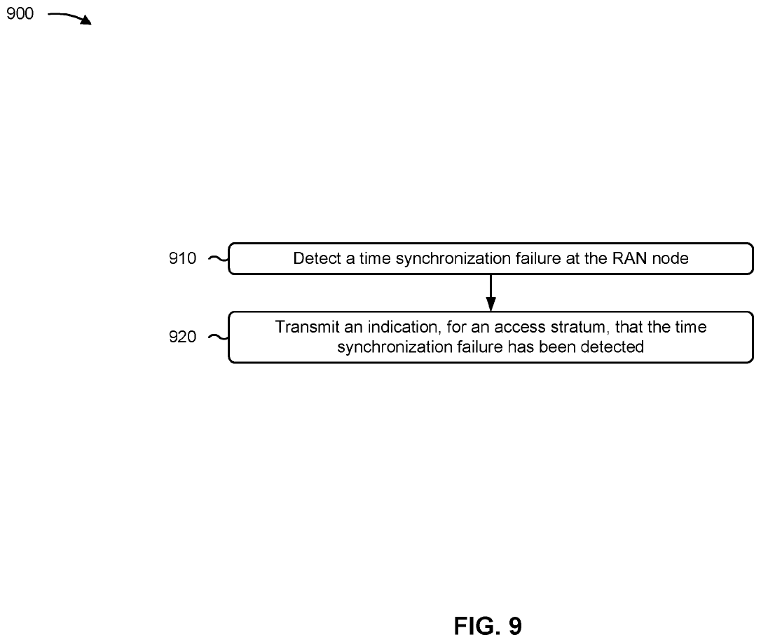

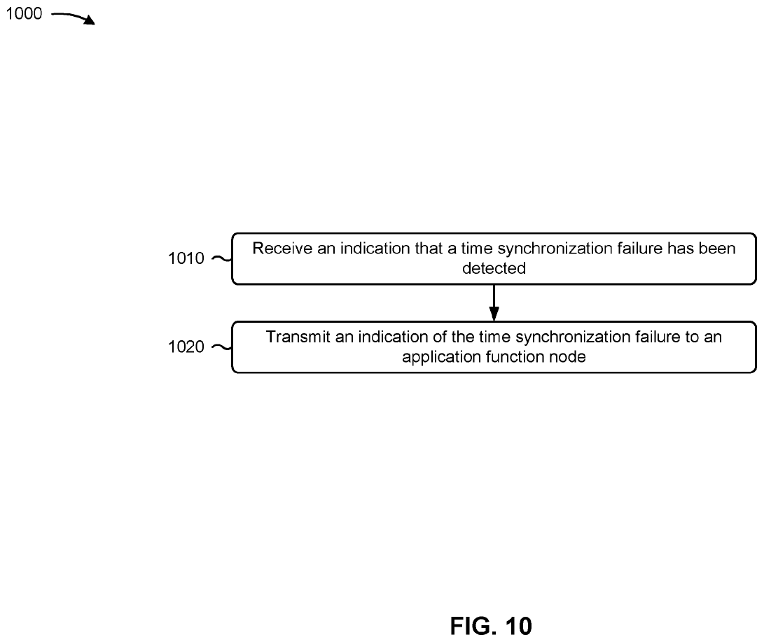

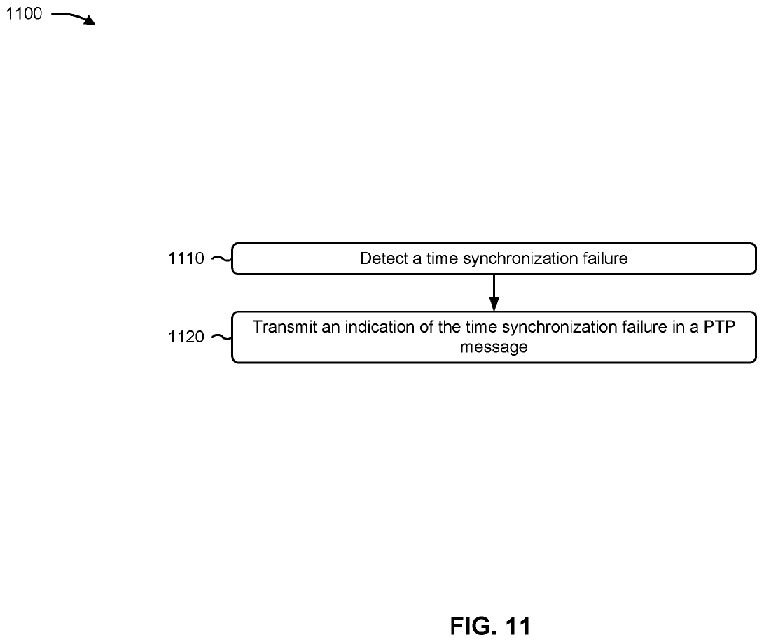

The controller/processor 240 of the base station 110, the controller/processor 280 of the UE 120, and/or any other component(s) of FIG. 2 may perform one or more techniques associated with indicating time synchronization changes, as described in more detail elsewhere herein. For example, the controller/processor 240 of the base station 110, the controller/processor 280 of the UE 120, and/or any other component(s) of FIG. 2 may perform or direct operations of, for example, process 800 of FIG. 8, process 900 of FIG. 9, process 1000 of FIG. 10, process 1100 of FIG. 11, and/or other processes as described herein. The memory 242 and the memory 282 may store data and program codes for the base station 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the base station 110 and/or the UE 120, may cause the one or more processors, the UE 120, and/or the base station 110 to perform or direct operations of, for example, process 800 of FIG. 8, process 900 of FIG. 9, process 1000 of FIG. 10, process 1100 of FIG. 11, and/or other processes as described herein. In some examples, executing instructions may include running the instructions, converting the instructions, compiling the instructions, and/or interpreting the instructions, among other examples. In some aspects, the RAN node described herein is the base station 110, is included in the base station 110, or includes one or more components of the base station 110 shown in FIG. 2. In some aspects, the time synchronization function node and/or the user plane function node described herein are the network controller 130, are included in the network controller 130, or include one or more components of the network controller 130 shown in FIG. 2.

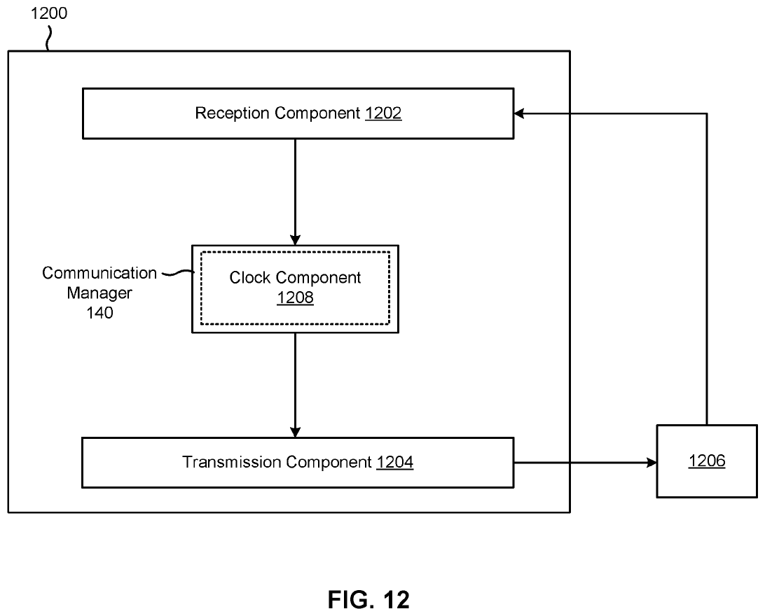

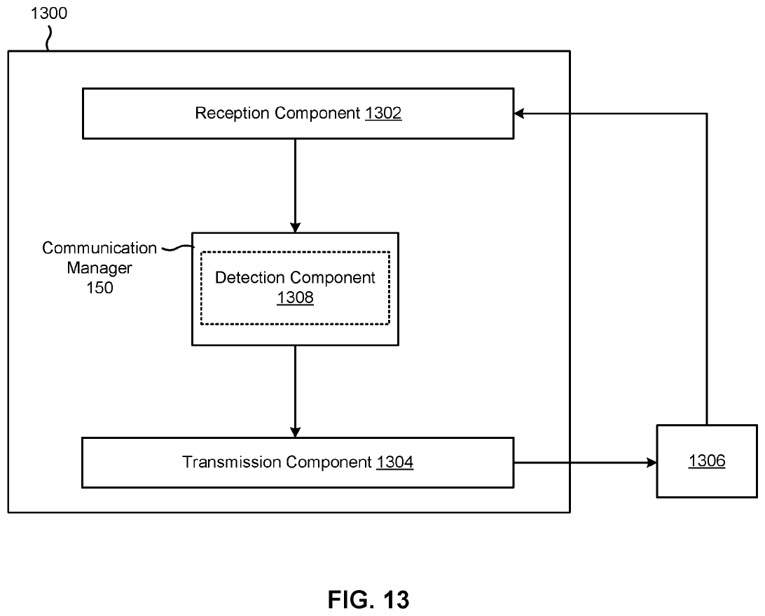

In some aspects, a UE (e.g., UE 120 and/or apparatus 1200 of FIG. 12) may include means for receiving, from a RAN node (e.g., base station 110 and/or apparatus 1300 of FIG. 13), an indication that a time synchronization change has been detected; and/or means for adjusting a clock associated with the UE based at least in part on the indication. The means for the UE to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, a RAN node (e.g., base station 110 and/or apparatus 1300 of FIG. 13) may include means for detecting a time synchronization change at the RAN node; and/or means for transmitting an indication, for an access stratum, that the time synchronization change has been detected. In some aspects, the means for the RAN node to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

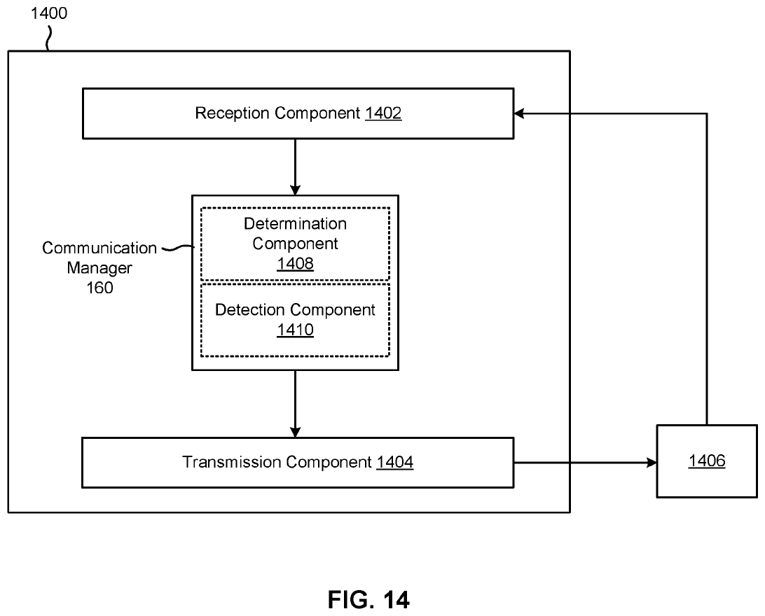

In some aspects, a time synchronization function node (e.g., network controller 130 and/or apparatus 1400 of FIG. 14) may include means for receiving an indication that a time synchronization change has been detected; and/or means for transmitting an indication of the time synchronization change to an application function node. In some aspects, the means for the time synchronization function node to perform operations described herein may include, for example, one or more of controller/processor 290, a memory 292, or communication unit 294.

In some aspects, a user plane function node (e.g., network controller 130 and/or apparatus 1400 of FIG. 14) may include means for detecting a time synchronization change; and/or means for transmitting an indication of the time synchronization change in a PTP message. In some aspects, the means for the user plane function node to perform operations described herein may include, for example, one or more of controller/processor 290, a memory 292, or communication unit 294.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

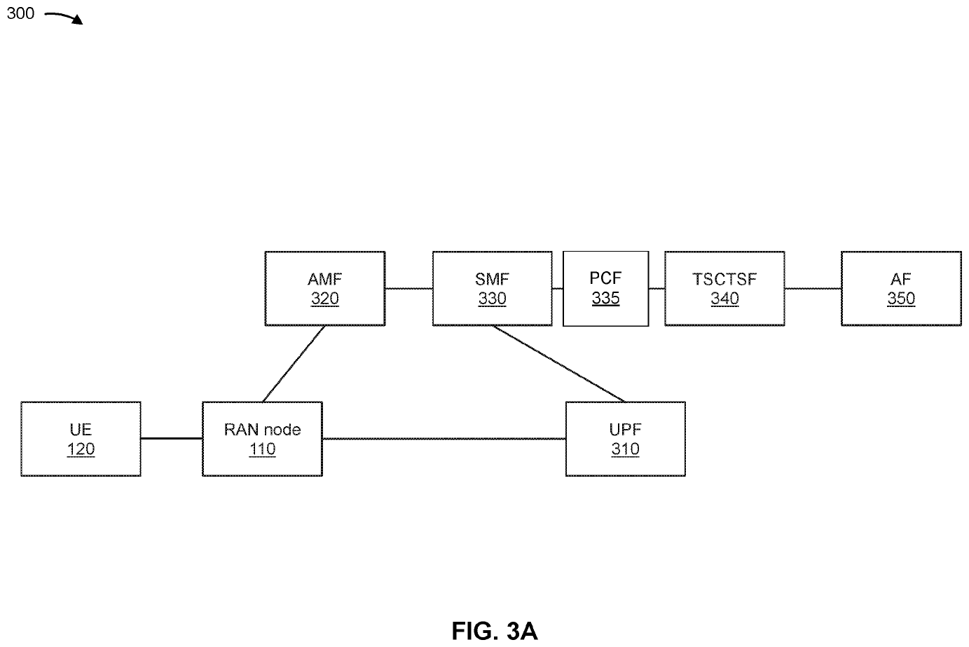

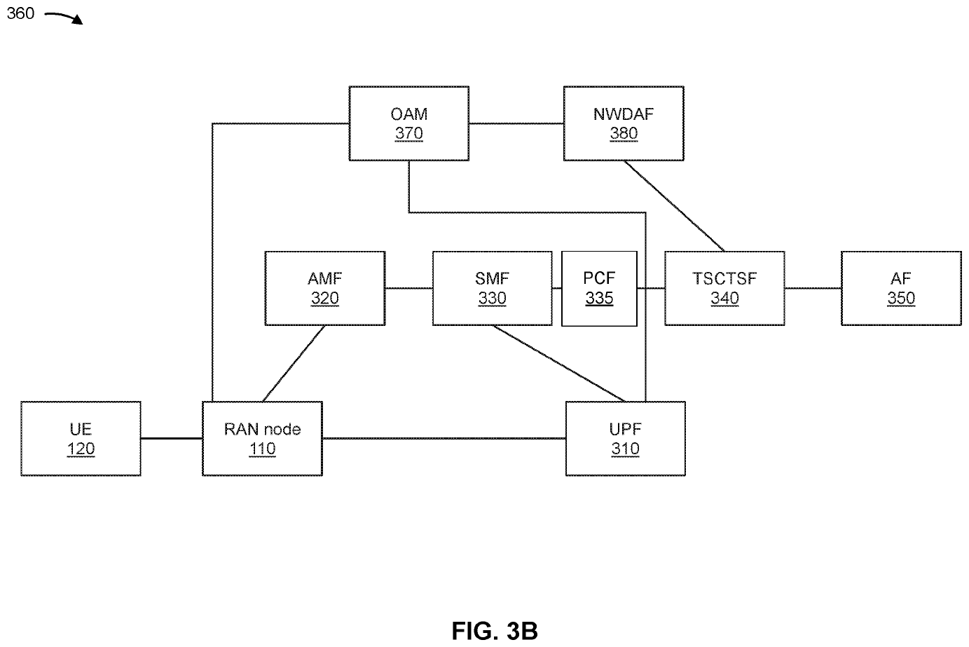

FIGS. 3A and 3B are diagrams of example core network architectures. As shown in FIG. 3A, example 300 may include a UE 120, a RAN node 110, and a core network including a user plane function (UPF) 310, an access and mobility function (AMF) 320, a session management function (SMF) 330, a policy control function (PCF) 335, a time sensitive communication time synchronization function (TSCTSF) 340, and an application function (AF) 350. Devices and/or nodes of example 300 may interconnect via wired connections, wireless connections, or a combination thereof.

The UE 120 may include one or more devices capable of receiving, generating, storing, processing, and/or providing information, such as information described herein. For example, the UE 120 may include a mobile phone (e.g., a smart phone, or a radiotelephone), a laptop computer, a tablet computer, a desktop computer, a handheld computer, a gaming device, a wearable communication device (e.g., a smart watch or a pair of smart glasses), a mobile hotspot device, a fixed wireless access device, customer premises equipment, an autonomous vehicle, or a similar type of device.

The RAN node 110 may be included in, for example, a cellular RAT and/or another wireless network. The wireless network may include one or more RAN nodes (e.g., base transceiver stations, radio base stations, node Bs, eNodeBs (eNBs), gNodeBs (gNBs), base station subsystems, cellular sites, cellular towers, access points, TRPs, radio access nodes, macrocell base stations, microcell base stations, picocell base stations, femtocell base stations, or similar types of devices) and other network entities that can support wireless communication for the UE 120. The wireless network may transfer traffic between the UE 120 (e.g., using a cellular RAT), the RAN node 110 (e.g., using a wireless interface or a backhaul interface, such as a wired backhaul interface), and/or the core network. The wireless network may provide one or more cells that cover geographic areas.

In some aspects, the RAN node 110 may perform scheduling and/or resource management for the UE 120 served by the RAN node 110 (e.g., the UE 120 covered by a cell provided by the wireless network including the RAN node 110). In some aspects, the wireless network may be controlled or coordinated by a network controller (e.g., network controller 130 of FIG. 1), which may perform load balancing and network-level configuration. As described above in connection with FIG. 1, the network controller may communicate with the wireless network via a wireless or wireline backhaul.

In some aspects, the core network may include an example functional architecture in which systems and/or methods described herein may be implemented. For example, the core network may include an example architecture of a 5G next generation (NG) core network included in a 5G wireless telecommunications system. Although the example architecture of the core network shown in FIG. 3A (and in FIG. 3B) may be an example of a service-based architecture, in some aspects, the core network may be implemented as a reference-point architecture, a 4G core network, and/or another type of architecture.

As shown in FIG. 3A, the core network may include a number of functional elements. The functional elements may include, for example, a UPF 310, an AMF 320, an SMF 330, a TSCTSF 340, and an AF 350, among other examples. These functional elements may be communicatively connected via a message bus. The message bus may be a logical and/or physical communication structure for communication among the functional elements. Accordingly, the message bus may permit communication between two or more functional elements, whether logically (e.g., using one or more application programming interfaces (APIs)) and/or physically (e.g., using one or more wired and/or wireless connections).

Each of the functional elements shown in FIG. 3A may be implemented on one or more devices associated with a wireless telecommunications system. In some implementations, one or more of the functional elements may be implemented on physical devices, such as an access point, a base station, a gateway, and/or another physical device. In some implementations, one or more of the functional elements may be implemented on a computing device of a cloud computing environment.

The UPF 310 may include one or more devices that serve as an anchor point for intra-RAT and/or inter-RAT mobility. In some aspects, the UPF 310 may apply rules to packets, such as rules pertaining to packet routing, traffic reporting, and handling user plane quality of service (QoS), among other examples.

The AMF 320 may include one or more devices that act as a termination point for non-access stratum (NAS) signaling and mobility management. In some aspects, the AMF track a location of the UE 120 and manage handover of the UE 120 between RAN nodes.

The SMF 330 may include one or more devices that support the establishment, modification, and release of communication sessions in the wireless telecommunications system. For example, the SMF 330 may configure traffic steering policies at the UPF 310 and enforce user equipment Internet protocol (IP) address allocation and policies.

The PCF 335 may include one or more devices that that provide a policy framework that incorporates roaming, packet processing, mobility management, and/or another similar function. Additionally, the PCF 335 may broker communications between the SMF 330 and the TSCTSF 340.

The TSCTSF 340 may include one or more devices that provide time synchronization information to the AF 350. Accordingly, applications on the AF 350 that are connected to the UE 120 through the core network and the RAN node 110 are aware of the time synchronization within the wireless network and the core network supporting the wireless network.

The AF 350 may include one or more devices that support application influence on traffic routing (e.g., to and from the UE 120) and policy control.

FIG. 3B shows an example 360 of core network architecture that is similar to example 300 of FIG. 3A but further includes an operations, administration, and maintenance (OAM) function 370 and a network data analytics function (NWDAF) 380.

The OAM function 370 may include one or more devices that monitor the hardware and software of RAN nodes (e.g., the RAN node 110) and the UPF 310.

The NWDAF 380 may include one or more devices that gathers information associated with the UE 120, the wireless network including the RAN node 110, and the core network and calculates analytics based on the gathered information. Different portions of the core network may subscribe to receive analytic updates from the NWDAF 380.

The number and arrangement of devices and networks shown in FIGS. 3A and 3B are provided as examples. In practice, there may be additional devices and/or networks, fewer devices and/or networks, different devices and/or networks, or differently arranged devices and/or networks than those shown in FIGS. 3A and 3B. Furthermore, two or more devices shown in FIGS. 3A and 3B may be implemented within a single device, or a single device shown in FIGS. 3A and 3B may be implemented as multiple, distributed devices. Additionally, or alternatively, a set of devices (e.g., one or more devices) of example 300 or example 360 may perform one or more functions described as being performed by another set of devices of example 300 or example 360.

As indicated above, FIGS. 3A and 3B are provided as examples. Other examples may differ from what is described with regard to FIGS. 3A and 3B.

In order to maintain time synchronization across UEs connected to a wireless network that is supported by a core network, there are typically two possible synchronization procedures. In one procedure, a RAN node transmits time synchronization updates to the UEs via an access stratum based on a grandmaster clock using a local global navigation satellite system (GNSS) receiver or transport network time synchronization information from the core network. In another procedure, the UEs exchange PTP messages (e.g., general PTP (gPTP) messages) to synchronize time with other devices (e.g., based on a grandmaster clock maintained by the wireless network) or with a UPF of the core network.

In some situations, time synchronization at the wireless network may fail (e.g., due to a loss of GNSS signal, a loss of traceability to coordinated universal time (UTC), and/or another decrease in synchronization quality that satisfies a failure threshold). This failure may prevent the UEs and/or applications supported by an AF of the core network from properly exchanging data or other signals. As a result, power and processing resources are wasted at the UEs and/or at the AF, and latency is increased because the data and/or other signals will be re-exchanged at a future time.

Some techniques and apparatuses described herein enable UEs and/or an AF supporting one or more applications connected to the UEs to be informed regarding time synchronization change. As a result, the UEs and/or the AF of the core network can conserve power and processing resources by refraining from some communications until time synchronization is restored.

FIG. 4 is a diagram illustrating an example 400 associated with indicating time synchronization changes using UEs and NAS signaling, in accordance with the present disclosure. As shown in FIG. 4, a RAN node 110 and a UE 120 may communicate with one another (e.g., using a wireless network, such as network 100 of FIG. 1). Additionally, the RAN node 110 may communicate with a TSCTSF 340 and an AF 350 (e.g., using a wired and/or wireless backhaul).

In example 400, the RAN node 110 uses a local GNSS receiver or uses transport network time synchronization information (e.g., from a core network including the TSCTSF 340 and the AF 350) to synchronize a clock at the RAN node 110.

As shown in connection with reference number 405, the RAN node 110 may detect time synchronization change at the RAN node 110. For example, the RAN node 110 may detect failure at the GNSS receiver (e.g., a lost signal, a jammed signal, a spoofed signal, and/or a signal that with a strength and/or quality that satisfies a failure threshold) of the RAN node 110. Additionally, or alternatively, the RAN node 110 may detect unavailability of transport network timing synchronization information. Accordingly, the RAN node 110 may switch to a local oscillator for time synchronization. Additionally, or alternatively, the RAN node 110 may receive an indication of grandmaster clock failure or degradation (e.g., change in clock class and/or loss of traceability to UTC) in transport network timing synchronization information. Accordingly, the RAN node 110 may maintain time synchronization with the transport network but without traceability to UTC.

As shown in connection with reference number 410, the RAN node 110 may transmit, and the UE 120 may receive, an indication that the time synchronization change has been detected. For example, the RAN node 110 may generate (e.g., at a central unit (CU) and/or a distributed unit (DU)) the indication and provide the indication to a radio unit (RU) for transmitting to the UE 120 over the access stratum. The RAN node 110 may indicate a new clock class associated with the clock at the RAN node 110, a loss of traceability to UTC, and/or information associated with quality of the clock at the RAN node 110.

In some aspects, the indication that the time synchronization change has been detected is included in a broadcast message (e.g., a system information block (SIB) broadcast over the access stratum by the RU at the direction of the RAN node 110). Additionally, or alternatively, the indication that the time synchronization change has been detected is included a dedicated radio resource control (RRC) message to the UE 120. For example, the RU may transmit the RRC message to the UE 120 over the access stratum at the direction of the RAN node 110.

Accordingly, as shown in connection with reference number 415, the UE 120 may adjust a clock associated with the UE 120 based, at least in part, on the indication from the RAN node 110. For example, the UE 120 may refrain from time-sensitive communications based on the indication that the time synchronization change has been detected. Additionally, or alternatively, in another example, the UE 120 may use a different clock source (e.g., disregard time synchronization information from the RAN node 110) in response to the indication from the RAN node 110. Accordingly, as used herein, “adjust a clock” refers to changing the clock, changing a source for the clock, and/or modifying or refraining from processes that are clock-dependent.

Additionally, as shown in connection with reference number 420, the TSCTSF 340 may transmit, and the UE 120 may receive, a request for a time synchronization status associated with the UE 120. The TSCTSF 340 may instruct the RAN node 110 to direct the RU to transmit the request to the UE 120 wirelessly. For example, the AF 350 may request that the TSCTSF 340 track time synchronization status for the UE 120 such that the TSCTSF 340 transmits the request to the UE 120 based, at least in part, on the request from the AF 350.

Accordingly, as shown in connection with reference number 425, the UE 120 may transmit, and the TSCTSF 340 may receive, an indication that a time synchronization change has been detected. For example, the UE 120 may transmit the indication to the TSCTSF 340 based, at least in part, on the request from the TSCTSF 340 and the indication from the RAN node 110. The UE 120 may wirelessly transmit the indication to the RU for transmission to the TSCTSF 340 on a backhaul via the RAN node 110.

In some aspects, the request and the indication that the time synchronization change has been detected are included in NAS messages. For example, the TSCTSF 340 may transmit a port management information container (PMIC) to the UE 120 with the request. Similarly, the UE 120 may transmit a PMIC to the TSCTSF 340 with the indication. Accordingly, the RU and the RAN node 110 may facilitate communication between the UE 120 and the TSCTSF 340 transparently.

As shown in connection with reference number 430, the TSCTSF 340 may transmit, and the AF 350 may receive, an indication of the time synchronization change. Accordingly, the AF 350 may refrain from time-sensitive communications based on the indication of the time synchronization change.

Similarly, the RAN node 110 may detect time synchronization restoration at the RAN node 110. For example, the RAN node 110 may detect restoration at the GNSS receiver (e.g., a recovered signal and/or a signal that with a strength and/or quality that no longer satisfies a failure threshold) of the RAN node 110. Additionally, or alternatively, the RAN node 110 may detect availability of transport network timing synchronization information. Accordingly, the RAN node 110 may switch away from the local oscillator for time synchronization. Additionally, or alternatively, the RAN node 110 may receive an indication of grandmaster clock restoration (e.g., restoration of traceability to UTC) in transport network timing synchronization information. Accordingly, the RAN node 110 may maintain time synchronization with the transport network and now with traceability to UTC.

Accordingly, the RAN node 110 may indicate, to the UE 120, that the time synchronization has been restored similarly as the RAN node 110 indicated a time synchronization failure, as described above. Additionally, the UE 120 may indicate, to the TSCTSF 340, when the time synchronization is restored similarly as the UE 120 indicated a time synchronization failure, as described above. Further, the TSCTSF 340 may indicate, to the AF 350, when the time synchronization is restored similarly as the TSCTSF 340 indicated a time synchronization failure, as described above.

By using the techniques as described in connection with FIG. 4, the UE 120 and the AF 350 supporting one or more applications connected to the UE 120 receive indications regarding time synchronization change at the RAN node 110. As a result, the UE 120 and the AF 350 can conserve power and processing resources by refraining from time sensitive communications until time synchronization is restored. Additionally, or alternatively, the UE 120 may refrain from performing time sensitive communications with external device (e.g., devices, such as robotic arms, within a manufacturing plant in order to prevent production faults that waste power and raw materials).

As indicated above, FIG. 4 is provided as an example. Other examples may differ from what is described with respect to FIG. 4.

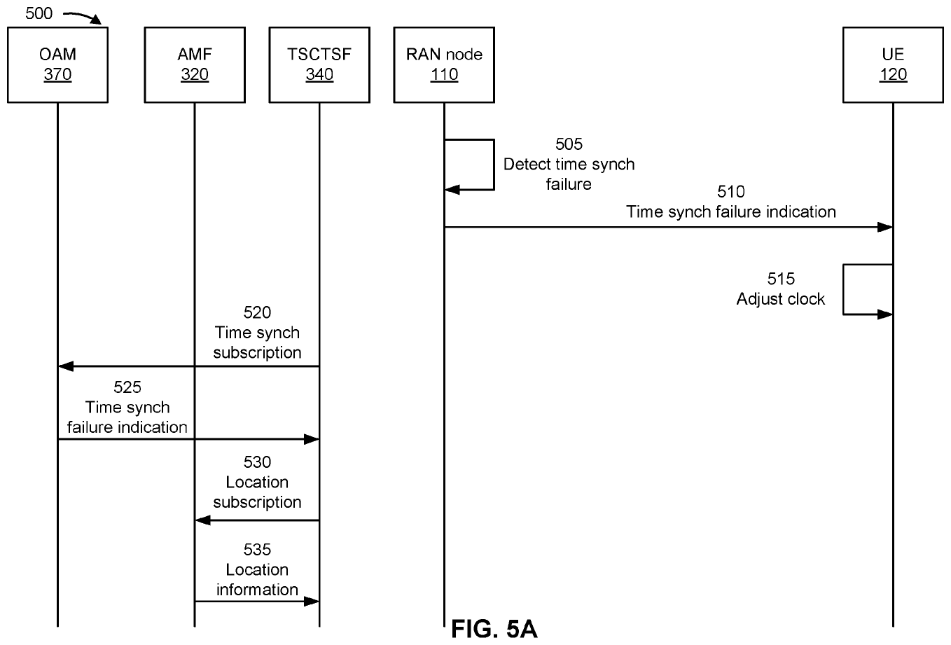

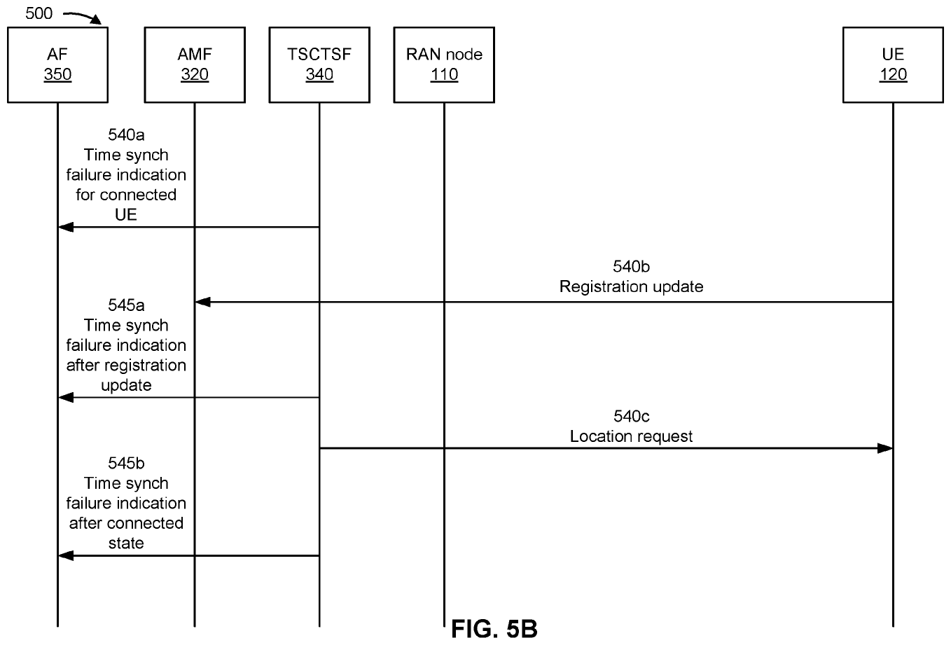

FIGS. 5A and 5B are a diagram illustrating an example 500 associated with indicating time synchronization changes using UEs and a management function node, in accordance with the present disclosure. As shown in FIG. 5A, a RAN node 110 and a UE 120 may communicate with one another (e.g., using a wireless network, such as network 100 of FIG. 1). Additionally, the RAN node 110 may communicate with an AMF 320, a TSCTSF 340, and an OAM 370 (e.g., using a wired and/or wireless backhaul).

In example 500, the RAN node 110 uses a local GNSS receiver or uses transport network time synchronization information (e.g., from a core network including the AMF 320, the TSCTSF 340, and the OAM 370) to synchronize a clock at the RAN node 110.

As shown in connection with reference number 505, the RAN node 110 may detect time synchronization change at the RAN node 110. For example, the RAN node 110 may detect failure as described in connection with reference number 405 of FIG. 4.

As shown in connection with reference number 510, the RAN node 110 may transmit, and the UE 120 may receive, an indication that the time synchronization change has been detected. For example, the RAN node 110 may transmit the indication as described in connection with reference number 410 of FIG. 4.

Accordingly, as shown in connection with reference number 515, the UE 120 may adjust a clock associated with the UE 120 based, at least in part, on the indication from the RAN node 110. For example, the UE 120 may refrain from time-sensitive communications based on the indication that the time synchronization change has been detected.

Additionally, as shown in connection with reference number 520, the TSCTSF 340 may subscribe to time synchronization statuses from the OAM 370. In some implementations, the TSCTSF 340 may subscribe to time synchronization statuses from an NWDAF, which in turn subscribes to time synchronization statuses from the OAM 370. The time synchronization statuses may indicate a new clock class associated with the clock at the RAN node 110, a loss of traceability to UTC, and/or information associated with quality of the clock at the RAN node 110.

Therefore, as shown in connection with reference number 525, the TSCTSF 340 may receive, from the OAM 370 (or, optionally, from the NWDAF) an indication that a time synchronization change has been detected. For example, the OAM 370 may transmit the indication to the TSCTSF 340 based, at least in part, on the subscription to time synchronization statuses.

Additionally, as shown in connection with reference number 530, the TSCTSF 340 may subscribe to location information from the AMF 320. In some implementations, the location information may include RAN node granularity (e.g., indicating which UEs are served by which RAN nodes). As an alternative, the location information may include tracking area granularity (e.g., based on the tracking areas used by the AMF 320 to track UEs within the wireless network including the RAN node 110).

Therefore, as shown in connection with reference number 535, the TSCTSF 340 may receive, from the AMF 320, location information associated with UEs within the wireless network including the RAN node 110. For example, the AMF 320 may transmit the indication to the TSCTSF 340 based, at least in part, on the subscription to location information.

As shown in FIG. 5B and in connection with reference number 540a, the TSCTSF 340 may transmit, to an AF 350 associated with the UE 120, an indication of the time synchronization change. When the UE 120 is in a connected state, the location information from the AMF 320 indicates that the RAN node 110 serves the UE 120. Accordingly, the TSCTSF 340 may determine that the time synchronization change is associated with the UE 120 based on the location information from the AMF 320 and based on an indication that the time synchronization change has been detected from the OAM 370 (optionally via the NWDAF).

Alternatively, and as shown in connection with reference number 540b, the UE 120 may be in an idle state. Accordingly, the UE 120 may perform a registration update (e.g., with the RAN node 110 that selects the AMF 320). For example, the UE 120 may perform the registration update based, at least in part, on receiving the indication from the RAN node 110 that the time synchronization change has been detected. As a result, the location information from the AMF 320 indicates that the RAN node 110 serves the UE 120 based on the registration update. Accordingly, the TSCTSF 340 may determine that the time synchronization change is associated with the UE 120 based on the location information from the AMF 320, after the UE 120 has performed the registration update, and based on an indication that the time synchronization change has been detected from the OAM 370 (optionally via the NWDAF). Therefore, as shown in connection with reference number 545a, the TSCTSF 340 may transmit, to an AF 350 associated with the UE 120, an indication of the time synchronization change.

Alternatively, and as shown in connection with reference number 540c, the TSCTSF 340 may trigger a network-initiated location request for the UE 120 (e.g., using a location management function (LMF) included in the core network). For example, the TSCTSF 340 may determine to trigger a network-initiated location request based on location information from the AMF 320 (e.g., indicating a tracking area associated with the UE 120) and based on an indication that the time synchronization change has been detected from the OAM 370 (optionally via the NWDAF). In some aspects, the LMF may perform the location request for the UE 120 when the UE 120 enters a connected state. As a result, the location information from the AMF 320 indicates that the RAN node 110 serves the UE 120 based on the registration update. Accordingly, the TSCTSF 340 may determine that the time synchronization change is associated with the UE 120 based on a result of the network-initiated location request and based on the indication that the time synchronization change has been detected from the OAM 370 (optionally via the NWDAF). Therefore, as shown in connection with reference number 545b, the TSCTSF 340 may transmit, to an AF 350 associated with the UE 120, an indication of the time synchronization change.

Accordingly, the AF 350 may refrain from time-sensitive communications based on the indication of the time synchronization change. Similarly, the RAN node 110 may detect time synchronization restoration at the RAN node 110 (e.g., as described in connection with FIG. 4). Accordingly, the RAN node 110 may indicate, to the UE 120, that the time synchronization has been restored similarly as the RAN node 110 indicated a time synchronization failure, as described above. Additionally, the TSCTSF 340 may determine that the time synchronization restoration is associated with the UE 120, as described above. Further, the TSCTSF 340 may indicate, to the AF 350, when the time synchronization is restored similarly as the TSCTSF 340 indicated a time synchronization failure, as described above.

By using the techniques as described in connection with FIGS. 5A and 5B, the UE 120 and the AF 350 supporting one or more applications connected to the UE 120 receive indications regarding time synchronization change at the RAN node 110. As a result, the UE 120 and the AF 350 can conserve power and processing resources by refraining from time sensitive communications until time synchronization is restored. Additionally, or alternatively, the UE 120 may refrain from performing time sensitive communications with external device (e.g., devices, such as robotic arms, within a manufacturing plant in order to prevent production faults that waste power and raw materials).

As indicated above, FIGS. 5A and 5B are provided as an example. Other examples may differ from what is described with respect to FIGS. 5A and 5B.

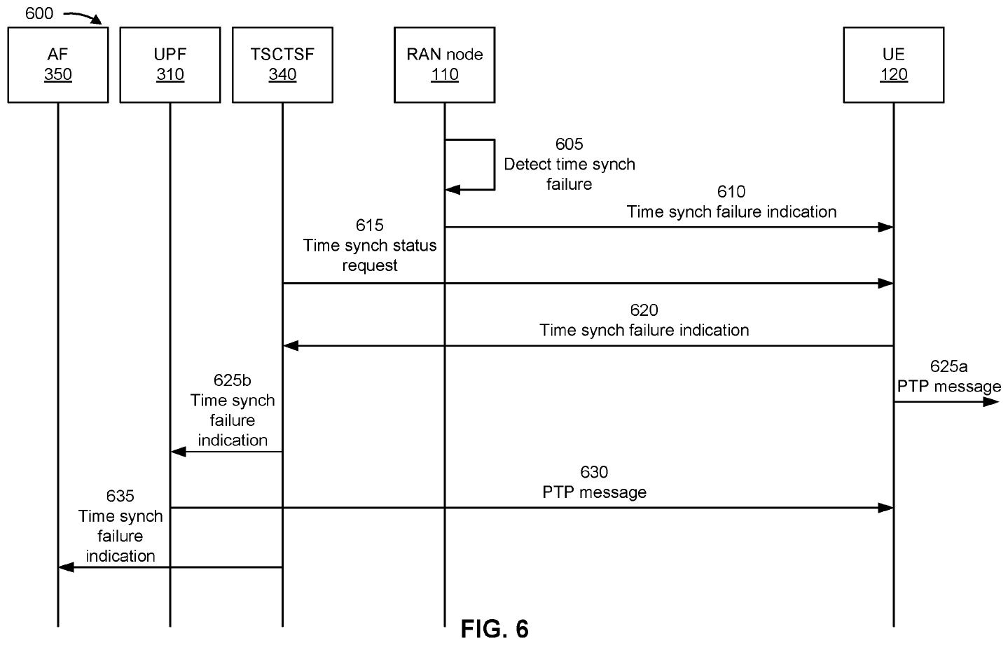

FIG. 6 is a diagram illustrating an example 600 associated with indicating time synchronization changes using UEs and NAS signaling, in accordance with the present disclosure. As shown in FIG. 6, a RAN node 110 and a UE 120 may communicate with one another (e.g., using a wireless network, such as network 100 of FIG. 1). Additionally, the RAN node 110 may communicate with a UPF 310, a TSCTSF 340, and an AF 350 (e.g., using a wired and/or wireless backhaul).

In example 600, the RAN node 110 uses a local GNSS receiver or uses transport network time synchronization information (e.g., from a core network including the TSCTSF 340 and the AF 350) to synchronize a clock at the RAN node 110. Additionally, in example 600, the UPF 310 exchanges PTP messages with the UE 120 to synchronize a clock at the UE 120, or the UE 120 exchanges PTP messages with an external device to synchronize the clock at the external device.

As shown in connection with reference number 605, the RAN node 110 may detect time synchronization change at the RAN node 110. For example, the RAN node 110 may detect failure as described in connection with reference number 405 of FIG. 4.

As shown in connection with reference number 610, the RAN node 110 may transmit, and the UE 120 may receive, an indication that the time synchronization change has been detected. For example, the RAN node 110 may transmit the indication as described in connection with reference number 410 of FIG. 4.

Accordingly, in some aspects, the UE 120 may adjust a clock associated with the UE 120 based, at least in part, on the indication from the RAN node 110. For example, the UE 120 may refrain from time-sensitive communications based on the indication that the time synchronization change has been detected.

As shown in connection with reference number 615, the TSCTSF 340 may transmit, and the UE 120 may receive, a request for a time synchronization status associated with the UE 120. For example, the TSCTSF 340 may transmit the request as described in connection with reference number 420 of FIG. 4.

Accordingly, as shown in connection with reference number 620, the UE 120 may transmit, and the TSCTSF 340 may receive, an indication that a time synchronization change has been detected. For example, the UE 120 may transmit the indication as described in connection with reference number 425 of FIG. 4.

In some aspects, the UE 120 may synchronize time using a PTP with an external device. Accordingly, as shown in connection with reference number 625a, the UE 120 may transmit a PTP message indicating the time synchronization change. For example, a device-side time sensitive networking (TSN) translator (DS-TT) co-located with the UE 120 may transmit the PTP message. As used herein, “co-located” refers to different logical protocol stacks implemented, at least in part, on a same hardware. In some aspects, the PTP message may indicate a new clock class associated with the clock at the RAN node 110, a loss of traceability to UTC, and/or information associated with quality of the clock at the RAN node 110.

As an alternative, the UE 120 may synchronize time using a PTP with the UPF 310. Accordingly, as shown in connection with reference number 625b, the TSCTSF 340 may transmit, and the UPF 310 may receive, an indication that the time synchronization change has been detected. Additionally, as shown in connection with reference number 630, the UPF 310 may transmit an indication of the time synchronization change in a PTP message (e.g., to the UE 120 and/or to other devices synchronizing time using the PTP with the UPF 310). In some aspects, a network-side TSN translator (NW-TT) co-located with the UPF 310 may receive the indication from the TSCTSF 340 and transmit the PTP message. In some aspects, the PTP message may indicate a new clock class associated with the clock at the RAN node 110, a loss of traceability to UTC, and/or information associated with quality of the clock at the RAN node 110.

Additionally with, or alternatively to, the RAN node 110 detecting time synchronization change, the UPF 310 may detect time synchronization change. For example, the UPF 310 may detect unavailability of transport network timing synchronization information. Accordingly, the UPF 310 may switch to a local oscillator for time synchronization. Additionally, or alternatively, the UPF 310 may receive an indication of grandmaster clock failure or degradation (e.g., change in clock class and/or loss of traceability to UTC) in transport network timing synchronization information. Accordingly, the UPF 310 may maintain time synchronization with the transport network but without traceability to UTC. As a result, the UPF 310 may indicate the time synchronization change in a PTP message to the UE 120 (e.g., similarly as described above in connection with reference number 630). Additionally, the UPF 310 may transmit, and the TSCTSF 340 may receive, an indication of the time synchronization change. For example, the indication may be included in a user plane node management information container (UMIC) or may be transmitted via an SMF node. In some aspects, the TSCTSF 340 may subscribe to time synchronization statuses from the UPF 310 such that the UPF 310 transmits the indication to the TSCTSF 340 based, at least in part, on a request to subscribe from the TSCTSF 340.

As shown in connection with reference number 635, the TSCTSF 340 may transmit, and the AF 350 may receive, an indication of the time synchronization change. Accordingly, the AF 350 may refrain from time-sensitive communications based on the indication of the time synchronization change.

Similarly, the RAN node 110 may detect time synchronization restoration at the RAN node 110 (e.g., as described in connection with FIG. 4). Accordingly, the RAN node 110 may indicate, to the UE 120, that the time synchronization has been restored similarly as the RAN node 110 indicated a time synchronization failure, as described above. Accordingly, in some aspects, the UE 120 may transmit a PTP message indicating the time synchronization restoration. Additionally, the UE 120 may indicate, to the TSCTSF 340, when the time synchronization is restored similarly as the UE 120 indicated a time synchronization failure, as described above. Further, the TSCTSF 340 may indicate, to the AF 350, when the time synchronization is restored similarly as the TSCTSF 340 indicated a time synchronization failure, as described above. In some aspects, the TSCTSF 340 may indicate the time synchronization restoration to the UPF 310, which in turn transmits a PTP message indicating the time synchronization restoration.

Similarly, the UPF 310 may detect time synchronization restoration at the UPF 310. Accordingly, the UPF 310 may indicate, to the UE 120, that the time synchronization has been restored similarly as the UPF 310 indicated a time synchronization failure, as described above. Additionally, the UPF 310 may indicate, to the TSCTSF 340, when the time synchronization is restored similarly as the UPF 310 indicated a time synchronization failure, as described above. Further, the TSCTSF 340 may indicate, to the AF 350, when the time synchronization is restored similarly as the TSCTSF 340 indicated atime synchronization failure, as described above.

By using the techniques as described in connection with FIG. 6, the UE 120 and the AF 350 supporting one or more applications connected to the UE 120 receive indications regarding time synchronization changes at the RAN node 110. As a result, the UE 120 and the AF 350 can conserve power and processing resources by refraining from time sensitive communications until time synchronization is restored.

As indicated above, FIG. 6 is provided as an example. Other examples may differ from what is described with respect to FIG. 6.

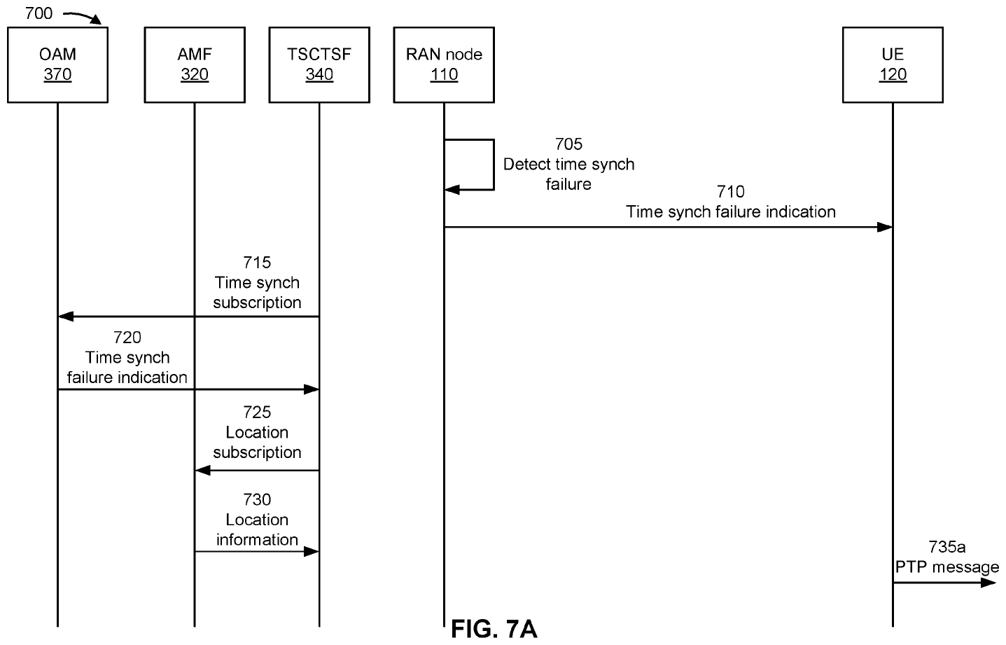

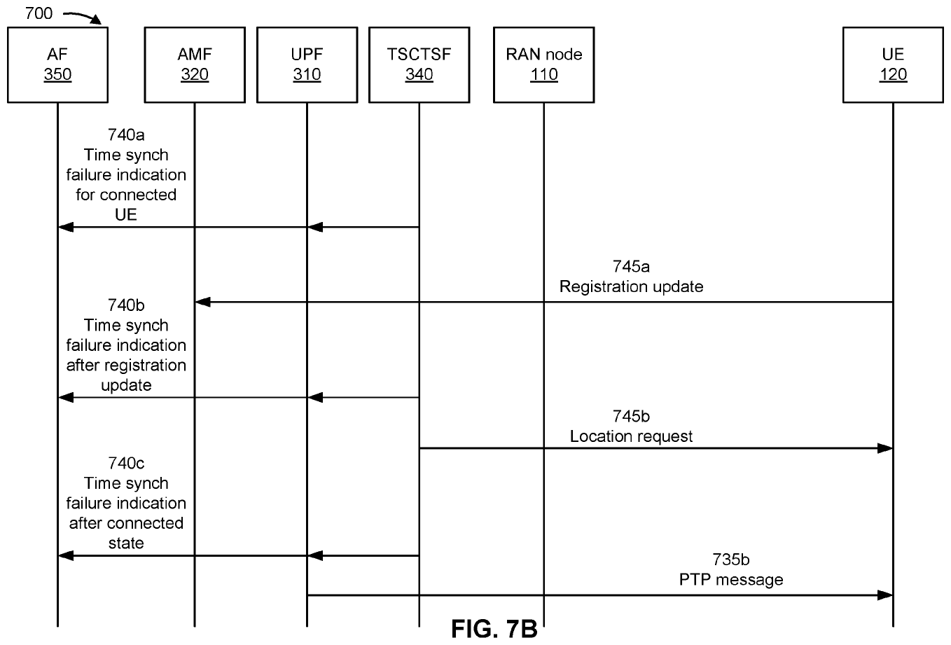

FIGS. 7A and 7B are a diagram illustrating an example 700 associated with indicating time synchronization changes using UEs and a management function node, in accordance with the present disclosure. As shown in FIG. 7A, a RAN node 110 and a UE 120 may communicate with one another (e.g., using a wireless network, such as network 100 of FIG. 1). Additionally, the RAN node 110 may communicate with an AMF 320, a TSCTSF 340, and an OAM 370 (e.g., using a wired and/or wireless backhaul).

In example 700, the RAN node 110 uses a local GNSS receiver or uses transport network time synchronization information (e.g., from a core network including the AMF 320, the TSCTSF 340, and the OAM 370) to synchronize a clock at the RAN node 110. Additionally, in example 700, the UPF 310 exchanges PTP messages with the UE 120 to synchronize a clock at the UE 120, or the UE 120 exchanges PTP messages with an external device to synchronize the clock at the UE 120.

As shown in connection with reference number 705, the RAN node 110 may detect time synchronization change at the RAN node 110. For example, the RAN node 110 may detect failure as described in connection with reference number 405 of FIG. 4.

As shown in connection with reference number 710, the RAN node 110 may transmit, and the UE 120 may receive, an indication that the time synchronization change has been detected. For example, the RAN node 110 may transmit the indication as described in connection with reference number 410 of FIG. 4.

Accordingly, in some aspects, the UE 120 may adjust a clock associated with the UE 120 based, at least in part, on the indication from the RAN node 110. For example, the UE 120 may refrain from time-sensitive communications based on the indication that the time synchronization change has been detected.

Additionally, as shown in connection with reference number 715, the TSCTSF 340 may subscribe to time synchronization statuses from the OAM 370. For example, the TSCTSF 340 may subscribe as described in connection with reference number 520 of FIG. 5A.

Therefore, as shown in connection with reference number 720, the TSCTSF 340 may receive, from the OAM 370 (optionally via the NWDAF) an indication that a time synchronization change has been detected. For example, the OAM 370 may transmit the indication as described in connection with reference number 525 of FIG. 5A.

Additionally, as shown in connection with reference number 725, the TSCTSF 340 may subscribe to location information from the AMF 320. For example, the TSCTSF 340 may subscribe as described in connection with reference number 530 of FIG. 5A.

Therefore, as shown in connection with reference number 730, the TSCTSF 340 may receive, from the AMF 320, location information associated with UEs within the wireless network including the RAN node 110. For example, the AMF 320 may transmit the indication as described in connection with reference number 535 of FIG. 5A.

In some aspects, the UE 120 may synchronize time using a PTP with an external device. Accordingly, as shown in connection with reference number 735a, the UE 120 may transmit a PTP message indicating the time synchronization change. For example, the UE 120 may transmit the PTP message as described in connection with reference number 625a of FIG. 6.

As an alternative, the UE 120 may synchronize time using a PTP with the UPF 310. Accordingly, as shown in FIG. 7B and described below in connection with reference numbers 740a, 740b, or 740c, the TSCTSF 340 may transmit, and the UPF 310 may receive, an indication that the time synchronization change has been detected. Additionally, as shown in connection with reference number 735b, the UPF 310 may transmit an indication of the time synchronization change in a PTP message (e.g., to the UE 120 and/or to other devices synchronizing time using the PTP with the UPF 310). For example, the UPF 310 may transmit the PTP message as described in connection with reference number 630 of FIG. 6.

As shown in connection with reference number 740a, the TSCTSF 340 may transmit, to an AF 350 associated with the UE 120, an indication of the time synchronization change. When the UE 120 is in a connected state, the location information from the AMF 320 indicates that the RAN node 110 serves the UE 120. Accordingly, the TSCTSF 340 may determine that the time synchronization change is associated with the UE 120 based on the location information from the AMF 320 and based on an indication that the time synchronization change has been detected from the OAM 370 (optionally via the NWDAF). Additionally, the TSCTSF 340 may transmit, to the UPF 310, an indication of the time synchronization change.

Alternatively, the UE 120 may be in an idle state. Accordingly, as shown in connection with reference number 745a, the UE 120 may perform a registration update (e.g., with the RAN node 110 that selects the AMF 320). For example, the UE 120 may perform the registration update based, at least in part, on receiving the indication from the RAN node 110 that the time synchronization change has been detected. As a result, the location information from the AMF 320 indicates that the RAN node 110 serves the UE 120 based on the registration update. Accordingly, the TSCTSF 340 may determine that the time synchronization change is associated with the UE 120 based on the location information from the AMF 320, after the UE 120 has performed the registration update, and based on an indication that the time synchronization change has been detected from the OAM 370 (optionally via the NWDAF). Therefore, as shown in connection with reference number 740b, the TSCTSF 340 may transmit, to an AF 350 associated with the UE 120, an indication of the time synchronization change. Additionally, the TSCTSF 340 may transmit, to the UPF 310, an indication of the time synchronization change.

Alternatively, and as shown in connection with reference number 745b, the TSCTSF 340 may trigger a network-initiated location request for the UE 120 (e.g., using an LMF included in the core network). For example, the TSCTSF 340 may determine to trigger a network-initiated location request based on location information from the AMF 320 (e.g., indicating a tracking area associated with the UE 120) and based on an indication that the time synchronization change has been detected from the OAM 370 (optionally via the NWDAF). In some aspects, the LMF may perform the location request for the UE 120 when the UE 120 enters a connected state. As a result, the location information from the AMF 320 indicates that the RAN node 110 serves the UE 120 based on the registration update. Accordingly, the TSCTSF 340 may determine that the time synchronization change is associated with the UE 120 based on a result of the network-initiated location request and based on the indication that the time synchronization change has been detected from the OAM 370 (optionally via the NWDAF). Therefore, as shown in connection with reference number 740c, the TSCTSF 340 may transmit, to an AF 350 associated with the UE 120, an indication of the time synchronization change. Additionally, the TSCTSF 340 may transmit, to the UPF 310, an indication of the time synchronization change.

Accordingly, the AF 350 may refrain from time-sensitive communications based on the indication of the time synchronization change. Additionally with, or alternatively to, the RAN node 110 detecting time synchronization change, the UPF 310 may detect time synchronization change. For example, the UPF 310 may detect time synchronization change as described in connection with FIG. 6. As a result, the UPF 310 may indicate the time synchronization change in a PTP message to the UE 120 (e.g., similarly as described above in connection with reference number 735b). Additionally, the UPF 310 may transmit, and the TSCTSF 340 may receive, an indication of the time synchronization change. For example, the indication may be included in a UMIC or may be transmitted via an SMF node. In some aspects, the TSCTSF 340 may subscribe to time synchronization statuses from the UPF 310 such that the UPF 310 transmits the indication to the TSCTSF 340 based, at least in part, on a request to subscribe from the TSCTSF 340.

Similarly, the RAN node 110 may detect time synchronization restoration at the RAN node 110 (e.g., as described in connection with FIG. 4). Accordingly, the RAN node 110 may indicate, to the UE 120, that the time synchronization has been restored similarly as the RAN node 110 indicated a time synchronization failure, as described above. Additionally, the TSCTSF 340 may determine that the time synchronization restoration is associated with the UE 120, as described above. Further, the TSCTSF 340 may indicate, to the AF 350 (optionally with the UPF 310), when the time synchronization is restored similarly as the TSCTSF 340 indicated a time synchronization failure, as described above.

Similarly, the UPF 310 may detect time synchronization restoration at the UPF 310. Accordingly, the UPF 310 may indicate, to the UE 120, that the time synchronization has been restored similarly as the UPF 310 indicated a time synchronization failure, as described above. Additionally, the UPF 310 may indicate, to the TSCTSF 340, when the time synchronization is restored similarly as the UPF 310 indicated a time synchronization failure, as described above. Further, the TSCTSF 340 may indicate, to the AF 350, when the time synchronization is restored similarly as the TSCTSF 340 indicated atime synchronization failure, as described above.

By using the techniques as described in connection with FIGS. 7A and 7B, the UE 120 and the AF 350 supporting one or more applications connected to the UE 120 receive indications regarding time synchronization changes at the RAN node 110. As a result, the UE 120 and the AF 350 can conserve power and processing resources by refraining from time sensitive communications until time synchronization is restored.

As indicated above, FIGS. 7A and 7B are provided as an example. Other examples may differ from what is described with respect to FIGS. 7A and 7B.

FIG. 8 is a diagram illustrating an example process 800 performed, for example, by a UE, in accordance with the present disclosure. Example process 800 is an example where the UE (e.g., UE 120 and/or apparatus 1200 of FIG. 12) performs operations associated with indicating time synchronization change.

As shown in FIG. 8, in some aspects, process 800 may include receiving, from a RAN node (e.g., RAN node 110 and/or apparatus 1300 of FIG. 13), an indication that atime synchronization change has been detected (block 810). For example, the UE (e.g., using communication manager 140 and/or reception component 1202, depicted in FIG. 12) may receive, from a RAN node, an indication that a time synchronization change has been detected, as described herein.

As further shown in FIG. 8, in some aspects, process 800 may include adjusting a clock associated with the UE based at least in part on the indication (block 820). For example, the UE (e.g., using communication manager 140 and/or clock component 1208, depicted in FIG. 12) may adjust a clock associated with the UE based at least in part on the indication, as described herein.

Process 800 may include additional aspects, such as any single aspect or any combination of aspects described below and/or in connection with one or more other processes described elsewhere herein.

In a first aspect, the indication that the time synchronization change has been detected is included in a broadcast message.

In a second aspect, alone or in combination with the first aspect, the indication that the time synchronization change has been detected is included a dedicated RRC message.

In a third aspect, alone or in combination with one or more of the first and second aspects, the indication that the time synchronization change has been detected is included in a PTP message.

In a fourth aspect, alone or in combination with one or more of the first through third aspects, process 800 further includes transmitting (e.g., using communication manager 140 and/or transmission component 1204, depicted in FIG. 12) a PTP message indicating the time synchronization change.

In a fifth aspect, alone or in combination with one or more of the first through fourth aspects, the PTP message is transmitted by a DS-TT co-located with the UE.

In a sixth aspect, alone or in combination with one or more of the first through fifth aspects, process 800 further includes receiving (e.g., using communication manager 140 and/or reception component 1202), from a time synchronization node, a request for a time synchronization status associated with the UE, and transmitting (e.g., using communication manager 140 and/or transmission component 1204), based at least in part on the request, an indication of the time synchronization change.

In a seventh aspect, alone or in combination with one or more of the first through sixth aspects, the request and the indication of the time synchronization change are included in NAS messages.

In an eighth aspect, alone or in combination with one or more of the first through seventh aspects, the NAS messages comprise PMICs.

In a ninth aspect, alone or in combination with one or more of the first through eighth aspects, process 800 further includes performing a registration update (e.g., using communication manager 140, reception component 1202 and/or transmission component 1204) with a network associated with the RAN node, based at least in part on the indication that the time synchronization change has been detected.

In a tenth aspect, alone or in combination with one or more of the first through ninth aspects, process 800 further includes performing a location procedure (e.g., using communication manager 140, reception component 1202 and/or transmission component 1204) with a network associated with the RAN node.

Although FIG. 8 shows example blocks of process 800, in some aspects, process 800 may include additional blocks, fewer blocks, different blocks, or differently arranged blocks than those depicted in FIG. 8. Additionally, or alternatively, two or more of the blocks of process 800 may be performed in parallel.

FIG. 9 is a diagram illustrating an example process 900 performed, for example, by a RAN node, in accordance with the present disclosure. Example process 900 is an example where the RAN node (e.g., RAN node 110 and/or apparatus 1300 of FIG. 13) performs operations associated with indicating time synchronization change.

As shown in FIG. 9, in some aspects, process 900 may include detecting a time synchronization change at the RAN node (block 910). For example, the RAN (e.g., using communication manager 150 and/or detection component 1308, depicted in FIG. 13) may detect a time synchronization change at the RAN node, as described herein.

As further shown in FIG. 9, in some aspects, process 900 may include transmitting an indication, for an access stratum, that the time synchronization change has been detected (block 920). For example, the RAN (e.g., using communication manager 150 and/or transmission component 1304, depicted in FIG. 13) may transmit an indication, for an access stratum, that the time synchronization change has been detected, as described herein.

Process 900 may include additional aspects, such as any single aspect or any combination of aspects described below and/or in connection with one or more other processes described elsewhere herein.

In a first aspect, detecting the time synchronization change includes at least one of detecting failure at a GNSS receiver of the RAN node, detecting unavailability of transport network timing synchronization information, or receiving an indication of grandmaster clock failure or degradation in transport network timing synchronization information.

In a second aspect, alone or in combination with the first aspect, the indication that the time synchronization change has been detected is included in a broadcast message.

In a third aspect, alone or in combination with one or more of the first and second aspects, the indication that the time synchronization change has been detected is included a dedicated RRC message.

In a fourth aspect, alone or in combination with one or more of the first through third aspects, process 900 further includes transmitting (e.g., using communication manager 150 and/or transmission component 1304) an indication of the time synchronization change to a management function node.

Although FIG. 9 shows example blocks of process 900, in some aspects, process 900 may include additional blocks, fewer blocks, different blocks, or differently arranged blocks than those depicted in FIG. 9. Additionally, or alternatively, two or more of the blocks of process 900 may be performed in parallel.

FIG. 10 is a diagram illustrating an example process 1000 performed, for example, by a time synchronization function node, in accordance with the present disclosure. Example process 1000 is an example where the time synchronization function node (e.g., time synchronization function node 340 and/or apparatus 1400 of FIG. 14) performs operations associated with indicating time synchronization change.

As shown in FIG. 10, in some aspects, process 1000 may include receiving an indication that a time synchronization change has been detected (block 1010). For example, the time synchronization function node (e.g., using communication manager 160 and/or reception component 1402, depicted in FIG. 14) may receive an indication that a time synchronization change has been detected, as described herein.

As further shown in FIG. 10, in some aspects, process 1000 may include transmitting an indication of the time synchronization change to an application function node (block 1020). For example, the time synchronization function node (e.g., using communication manager 160 and/or transmission component 1404, depicted in FIG. 14) may transmit an indication of the time synchronization change to an application function node, as described herein.

Process 1000 may include additional aspects, such as any single aspect or any combination of aspects described below and/or in connection with one or more other processes described elsewhere herein.

In a first aspect, process 1000 further includes transmitting (e.g., using communication manager 160 and/or transmission component 1404), to a UE via a RAN node, a request for a time synchronization status associated with the UE, where the indication that the time synchronization change has been detected is received from the UE via the RAN node.

In a second aspect, alone or in combination with the first aspect, the request and the indication that the time synchronization change has been detected are included in NAS messages.

In a third aspect, alone or in combination with one or more of the first and second aspects, the NAS messages comprise PMICs.

In a fourth aspect, alone or in combination with one or more of the first through third aspects, process 1000 further includes subscribing (e.g., using communication manager 160 and/or transmission component 1404) to time synchronization statuses from a management function node, where the indication that the time synchronization change has been detected is received from the management function node.

In a fifth aspect, alone or in combination with one or more of the first through fourth aspects, process 1000 further includes subscribing (e.g., using communication manager 160 and/or transmission component 1404) to location information from a mobility function node.

In a sixth aspect, alone or in combination with one or more of the first through fifth aspects, the application function node is associated with a UE that is in a connected state.

In a seventh aspect, alone or in combination with one or more of the first through sixth aspects, process 1000 includes determining (e.g., using communication manager 160 and/or determination component 1408, depicted in FIG. 14) that the time synchronization change is associated with a UE that was in an idle state based on the location information from the mobility function node after the UE has performed a registration update.

In an eighth aspect, alone or in combination with one or more of the first through seventh aspects, process 1000 further includes triggering a network-initiated location request (e.g., using communication manager 160 and/or transmission component 1404) for a UE in an idle state based at least in part on a tracking area associated with the UE and indicated in the location information from the mobility function node, where the indication of the time synchronization change is transmitted after the UE has entered a connected state.

Although FIG. 10 shows example blocks of process 1000, in some aspects, process 1000 may include additional blocks, fewer blocks, different blocks, or differently arranged blocks than those depicted in FIG. 10. Additionally, or alternatively, two or more of the blocks of process 1000 may be performed in parallel.

FIG. 11 is a diagram illustrating an example process 1100 performed, for example, by a user plane function node, in accordance with the present disclosure. Example process 1100 is an example where the user plane function node (e.g., user plane function node 310 and/or apparatus 1400 of FIG. 14) performs operations associated with indicating time synchronization change.

As shown in FIG. 11, in some aspects, process 1100 may include detecting a time synchronization change (block 1110). For example, the user plane function node (e.g., using communication manager 160 and/or detection component 1410, depicted in FIG. 14) may detect a time synchronization change, as described herein.

As further shown in FIG. 11, in some aspects, process 1100 may include transmitting an indication of the time synchronization change in a PTP message (block 1120). For example, the user plane function node (e.g., using communication manager 160 and/or transmission component 1404, depicted in FIG. 14) may transmit an indication of the time synchronization change in a PTP message, as described herein.

Process 1100 may include additional aspects, such as any single aspect or any combination of aspects described below and/or in connection with one or more other processes described elsewhere herein.

In a first aspect, detecting the time synchronization change includes receiving, from a time synchronization function node, an indication that the time synchronization change has been detected.

In a second aspect, alone or in combination with the first aspect, the indication that the time synchronization change has been detected is received at an NW-TT co-located with the user plane function node.

In a third aspect, alone or in combination with one or more of the first and second aspects, detecting the time synchronization change includes at least one of: detecting unavailability of transport network timing synchronization information, or receiving an indication of grandmaster clock failure or degradation in transport network timing synchronization information.

In a fourth aspect, alone or in combination with one or more of the first through third aspects, process 1100 further includes transmitting (e.g., using communication manager 160 and/or transmission component 1404), to a time synchronization function node, an indication of the time synchronization change.

In a fifth aspect, alone or in combination with one or more of the first through fourth aspects, the indication of the time synchronization change is included in a UMIC.

In a sixth aspect, alone or in combination with one or more of the first through fifth aspects, the indication of the time synchronization change is transmitted via a session management function node.

In a seventh aspect, alone or in combination with one or more of the first through sixth aspects, process 1100 further includes receiving (e.g., using communication manager 160 and/or reception component 1402, depicted in FIG. 14), from the time synchronization function node, a request to subscribe to time synchronization statuses, where the indication of the time synchronization change is transmitted based at least in part on the request to subscribe.

In an eighth aspect, alone or in combination with one or more of the first through seventh aspects, the PTP message is for a UE served by the user plane function node.

Although FIG. 11 shows example blocks of process 1100, in some aspects, process 1100 may include additional blocks, fewer blocks, different blocks, or differently arranged blocks than those depicted in FIG. 11. Additionally, or alternatively, two or more of the blocks of process 1100 may be performed in parallel.

FIG. 12 is a diagram of an example apparatus 1200 for wireless communication. The apparatus 1200 may be a UE, or a UE may include the apparatus 1200. In some aspects, the apparatus 1200 includes a reception component 1202 and a transmission component 1204, which may be in communication with one another (for example, via one or more buses and/or one or more other components). As shown, the apparatus 1200 may communicate with another apparatus 1206 (such as a UE, a base station, or another wireless communication device) using the reception component 1202 and the transmission component 1204. As further shown, the apparatus 1200 may include the communication manager 140. The communication manager 140 may include a clock component 1208, among other examples.

In some aspects, the apparatus 1200 may be configured to perform one or more operations described herein in connection with FIGS. 4, 5A-5B, 6, and/or 7A-7B. Additionally, or alternatively, the apparatus 1200 may be configured to perform one or more processes described herein, such as process 800 of FIG. 8, or a combination thereof. In some aspects, the apparatus 1200 and/or one or more components shown in FIG. 12 may include one or more components of the UE described in connection with FIG. 2. Additionally, or alternatively, one or more components shown in FIG. 12 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1202 may receive communications, such as reference signals, control information, data communications, or a combination thereof, from the apparatus 1206. The reception component 1202 may provide received communications to one or more other components of the apparatus 1200. In some aspects, the reception component 1202 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1200. In some aspects, the reception component 1202 may include one or more antennas, a modem, a demodulator, a MIMO detector, a receive processor, a controller/processor, a memory, or a combination thereof, of the UE described in connection with FIG. 2.

The transmission component 1204 may transmit communications, such as reference signals, control information, data communications, or a combination thereof, to the apparatus 1206. In some aspects, one or more other components of the apparatus 1200 may generate communications and may provide the generated communications to the transmission component 1204 for transmission to the apparatus 1206. In some aspects, the transmission component 1204 may perform signal processing on the generated communications (such as filtering, amplification, modulation, digital-to-analog conversion, multiplexing, interleaving, mapping, or encoding, among other examples), and may transmit the processed signals to the apparatus 1206. In some aspects, the transmission component 1204 may include one or more antennas, a modem, a modulator, a transmit MIMO processor, a transmit processor, a controller/processor, a memory, or a combination thereof, of the UE described in connection with FIG. 2. In some aspects, the transmission component 1204 may be co-located with the reception component 1202 in a transceiver.

In some aspects, the reception component 1202 may receive (e.g., from the apparatus 1206, such as a RAN node), an indication that a time synchronization change has been detected. Accordingly, the clock component 1208 may adjust a clock associated with the apparatus 1200 based at least in part on the indication. Additionally, in some aspects, the transmission component 1204 may transmit a PTP message indicating the time synchronization change.

In some aspects, the reception component 1202 may receive (e.g., from a time synchronization node) a request for a time synchronization status associated with the apparatus 1200. Accordingly, the transmission component 1204 may transmit, based at least in part on the request, an indication of the time synchronization change.

In some aspects, the transmission component 1204 and/or the reception component 1202 may perform a registration update with a network associated with the RAN node, based at least in part on the indication that the time synchronization change has been detected. Alternatively, the transmission component 1204 and/or the reception component 1202 may perform a location procedure with a network associated with the RAN node.

The number and arrangement of components shown in FIG. 12 are provided as an example. In practice, there may be additional components, fewer components, different components, or differently arranged components than those shown in FIG. 12. Furthermore, two or more components shown in FIG. 12 may be implemented within a single component, or a single component shown in FIG. 12 may be implemented as multiple, distributed components. Additionally, or alternatively, a set of (one or more) components shown in FIG. 12 may perform one or more functions described as being performed by another set of components shown in FIG. 12.

FIG. 13 is a diagram of an example apparatus 1300 for wireless communication. The apparatus 1300 may be a RAN node, or a RAN node may include the apparatus 1300. In some aspects, the apparatus 1300 includes a reception component 1302 and a transmission component 1304, which may be in communication with one another (for example, via one or more buses and/or one or more other components). As shown, the apparatus 1300 may communicate with another apparatus 1306 (such as a UE, a base station, or another wireless communication device) using the reception component 1302 and the transmission component 1304. As further shown, the apparatus 1300 may include the communication manager 150. The communication manager 150 may include a detection component 1308, among other examples.

In some aspects, the apparatus 1300 may be configured to perform one or more operations described herein in connection with FIGS. 4, 5A-5B, 6, and/or 7A-7B. Additionally, or alternatively, the apparatus 1300 may be configured to perform one or more processes described herein, such as process 900 of FIG. 9, or a combination thereof. In some aspects, the apparatus 1300 and/or one or more components shown in FIG. 13 may include one or more components of the base station described in connection with FIG. 2. Additionally, or alternatively, one or more components shown in FIG. 13 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1302 may receive communications, such as reference signals, control information, data communications, or a combination thereof, from the apparatus 1306. The reception component 1302 may provide received communications to one or more other components of the apparatus 1300. In some aspects, the reception component 1302 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1300. In some aspects, the reception component 1302 may include one or more antennas, a modem, a demodulator, a MIMO detector, a receive processor, a controller/processor, a memory, or a combination thereof, of the base station described in connection with FIG. 2.

The transmission component 1304 may transmit communications, such as reference signals, control information, data communications, or a combination thereof, to the apparatus 1306. In some aspects, one or more other components of the apparatus 1300 may generate communications and may provide the generated communications to the transmission component 1304 for transmission to the apparatus 1306. In some aspects, the transmission component 1304 may perform signal processing on the generated communications (such as filtering, amplification, modulation, digital-to-analog conversion, multiplexing, interleaving, mapping, or encoding, among other examples), and may transmit the processed signals to the apparatus 1306. In some aspects, the transmission component 1304 may include one or more antennas, a modem, a modulator, a transmit MIMO processor, a transmit processor, a controller/processor, a memory, or a combination thereof, of the base station described in connection with FIG. 2. In some aspects, the transmission component 1304 may be co-located with the reception component 1302 in a transceiver.

In some aspects, the detection component 1308 may detect a time synchronization change at the RAN node. Accordingly, the transmission component 1304 may transmit an indication, for an access stratum, that the time synchronization change has been detected. In some aspects, the transmission component 1304 may further transmit an indication of the time synchronization change to a management function node.

The number and arrangement of components shown in FIG. 13 are provided as an example. In practice, there may be additional components, fewer components, different components, or differently arranged components than those shown in FIG. 13. Furthermore, two or more components shown in FIG. 13 may be implemented within a single component, or a single component shown in FIG. 13 may be implemented as multiple, distributed components. Additionally, or alternatively, a set of (one or more) components shown in FIG. 13 may perform one or more functions described as being performed by another set of components shown in FIG. 13.

FIG. 14 is a diagram of an example apparatus 1400 for wireless communication. The apparatus 1400 may be a core network node, or a core network node may include the apparatus 1400. In some aspects, the apparatus 1400 includes a reception component 1402 and a transmission component 1404, which may be in communication with one another (for example, via one or more buses and/or one or more other components). As shown, the apparatus 1400 may communicate with another apparatus 1406 (such as a UE, a base station, or another wireless communication device) using the reception component 1402 and the transmission component 1404. As further shown, the apparatus 1400 may include the communication manager 160. The communication manager 160 may include a determination component 1408 and/or a detection component 1410, among other examples.

In some aspects, the apparatus 1400 may be configured to perform one or more operations described herein in connection with FIGS. 4, 5A-5B, 6, and/or 7A-7B. Additionally, or alternatively, the apparatus 1400 may be configured to perform one or more processes described herein, such as process 1000 of FIG. 10, process 1100 of FIG. 11, or a combination thereof. In some aspects, the apparatus 1400 and/or one or more components shown in FIG. 14 may include one or more components of the network controller described in connection with FIG. 2. Additionally, or alternatively, one or more components shown in FIG. 14 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1402 may receive communications, such as reference signals, control information, data communications, or a combination thereof, from the apparatus 1406. The reception component 1402 may provide received communications to one or more other components of the apparatus 1400. In some aspects, the reception component 1402 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1400. In some aspects, the reception component 1402 may include a communication unit, a controller/processor, a memory, or a combination thereof, of the network controller described in connection with FIG. 2.

The transmission component 1404 may transmit communications, such as reference signals, control information, data communications, or a combination thereof, to the apparatus 1406. In some aspects, one or more other components of the apparatus 1400 may generate communications and may provide the generated communications to the transmission component 1404 for transmission to the apparatus 1406. In some aspects, the transmission component 1404 may perform signal processing on the generated communications (such as filtering, amplification, modulation, digital-to-analog conversion, multiplexing, interleaving, mapping, or encoding, among other examples), and may transmit the processed signals to the apparatus 1406. In some aspects, the transmission component 1404 may include a communication unit, a controller/processor, a memory, or a combination thereof, of the network controller described in connection with FIG. 2. In some aspects, the transmission component 1404 may be co-located with the reception component 1402 in a transceiver.

In some aspects, the apparatus 1400 may include a time synchronization function node. Accordingly, the reception component 1402 may receive an indication that a time synchronization change has been detected. Additionally, the transmission component 1404 may transmit an indication of the time synchronization change to an application function node.

In some aspects, the transmission component 1404 may transmit (e.g., to a UE via the apparatus 1406, such as a RAN node) a request for a time synchronization status associated with the UE. Accordingly, the reception component 1402 may receive the indication that the time synchronization change has been detected from the UE via the apparatus 1406.

In some aspects, the transmission component 1404 may subscribe to time synchronization statuses from a management function node. Accordingly, the reception component 1402 may receive the indication that the time synchronization change has been detected from the management function node. Additionally, in some aspects, the transmission component 1404 may subscribe to location information from a mobility function node. Accordingly, the reception component 1402 may receive the indication that the time synchronization change has been detected from the mobility function node.

In some aspects, the determination component 1408 may determine that the time synchronization change is associated with a UE that was in an idle state based on the location information from the mobility function node after the UE has performed a registration update. Alternatively, the transmission component 1404 may trigger a network-initiated location request for a UE in an idle state based at least in part on a tracking area associated with the UE and indicated in the location information from the mobility function node. As a result, the transmission component 1404 transmits the indication of the time synchronization change after the UE has entered a connected state.

Alternatively, the apparatus 1400 may include a user plane function node. Accordingly, the detection component 1410 may detect a time synchronization change. Additionally, the transmission component 1404 may transmit an indication of the time synchronization change in a PTP message.

In some aspects, the transmission component 1404 may transmit, to a time synchronization function node, an indication of the time synchronization change. For example, the reception component 1402 may receive, from the time synchronization function node, a request to subscribe to time synchronization statuses, such that the transmission component 1404 transmits the indication of the time synchronization change based at least in part on the request to subscribe.

The number and arrangement of components shown in FIG. 14 are provided as an example. In practice, there may be additional components, fewer components, different components, or differently arranged components than those shown in FIG. 14. Furthermore, two or more components shown in FIG. 14 may be implemented within a single component, or a single component shown in FIG. 14 may be implemented as multiple, distributed components. Additionally, or alternatively, a set of (one or more) components shown in FIG. 14 may perform one or more functions described as being performed by another set of components shown in FIG. 14.

The following provides an overview of some Aspects of the present disclosure:

Aspect 1: A method of wireless communication performed by a user equipment (UE), comprising: receiving, from a radio access network (RAN) node, an indication that a time synchronization change has been detected; and adjusting a clock associated with the UE based at least in part on the indication.

Aspect 2: The method of Aspect 1, wherein the indication that the time synchronization change has been detected is included in a broadcast message.

Aspect 3: The method of Aspect 1, wherein the indication that the time synchronization change has been detected is included a dedicated radio resource control (RRC) message.

Aspect 4: The method of any of Aspect 1, wherein the indication that the time synchronization change has been detected is included in a precision time protocol (PTP) message.

Aspect 5: The method of any of Aspects 1 through 4, further comprising: transmitting a precision time protocol (PTP) message indicating the time synchronization change.

Aspect 6: The method of Aspect 5, wherein the PTP message is transmitted by a device-side time sensitive networking (TSN) translator (DS-TT) co-located with the UE.

Aspect 7: The method of any of Aspects 1 through 6, further comprising: receiving, from a time synchronization node, a request for a time synchronization status associated with the UE; and transmitting, based at least in part on the request, an indication of the time synchronization change.

Aspect 8: The method of Aspect 7, wherein the request and the indication of the time synchronization change are included in non-access stratum (NAS) messages.

Aspect 9: The method of Aspect 8, wherein the NAS messages comprise port management information containers (PMICs).

Aspect 10: The method of any of Aspects 1 through 8, further comprising: performing a registration update with a network associated with the RAN node, based at least in part on the indication that the time synchronization change has been detected.

Aspect 11: The method of any of Aspects 1 through 8, further comprising: performing a location procedure with a network associated with the RAN node.

Aspect 12: A method of wireless communication performed by a radio access network (RAN) node, comprising: detecting a time synchronization change at the RAN node; and transmitting an indication, for an access stratum, that the time synchronization change has been detected.

Aspect 13: The method of Aspect 12, wherein detecting the time synchronization change comprises at least one of: detecting failure at a global navigation satellite system (GNSS) receiver of the RAN node; detecting unavailability of transport network timing synchronization information; or receiving an indication of grandmaster clock failure or degradation in transport network timing synchronization information.

Aspect 14: The method of Aspect 12 or Aspect 13, wherein the indication that the time synchronization change has been detected is included in a broadcast message.

Aspect 15: The method of Aspect 12 or Aspect 13, wherein the indication that the time synchronization change has been detected is included a dedicated radio resource control (RRC) message.

Aspect 16: The method of any of Aspects 12 through 15, further comprising: transmitting an indication of the time synchronization change to a management function node.

Aspect 17: A method of wireless communication performed by a time synchronization function node, comprising: receiving an indication that a time synchronization change has been detected; and transmitting an indication of the time synchronization change to an application function node.

Aspect 18: The method of Aspect 17, further comprising: transmitting, to a user equipment (UE) via a radio access network (RAN) node, a request for a time synchronization status associated with the UE, wherein the indication that the time synchronization change has been detected is received from the UE via the RAN node.

Aspect 19: The method of Aspect 18, wherein the request and the indication that the time synchronization change has been detected are included in non-access stratum (NAS) messages.

Aspect 20: The method of Aspect 19, wherein the NAS messages comprise port management information containers (PMICs).

Aspect 21: The method of Aspect 17, further comprising: subscribing to time synchronization statuses from a management function node, wherein the indication that the time synchronization change has been detected is received from the management function node.

Aspect 22: The method of Aspect 21, further comprising: subscribing to location information from a mobility function node.

Aspect 23: The method of Aspect 22, wherein the application function node is associated with a user equipment (UE) that is in a connected state.

Aspect 24: The method of Aspect 22, further comprising: determining that the time synchronization change is associated with a user equipment (UE) that was in an idle state based on the location information from the mobility function node after the UE has performed a registration update.

Aspect 25: The method of Aspect 22, further comprising: triggering a network-initiated location request for a user equipment (UE) in an idle state based at least in part on a tracking area associated with the UE and indicated in the location information from the mobility function node, wherein the indication of the time synchronization change is transmitted after the UE has entered a connected state.

Aspect 26: A method of wireless communication performed by a user plane function node, comprising: detecting a time synchronization change; and transmitting an indication of the time synchronization change in a precision time protocol (PTP) message.

Aspect 27: The method of Aspect 26, wherein detecting the time synchronization change comprises: receiving, from a time synchronization function node, an indication that the time synchronization change has been detected.

Aspect 28: The method of Aspect 27, wherein the indication that the time synchronization change has been detected is received at a network-side time sensitive networking (TSN) translator (NW-TT) co-located with the user plane function node.

Aspect 29: The method of Aspect 26, wherein detecting the time synchronization change comprises at least one of: detecting unavailability of transport network timing synchronization information; or receiving an indication of grandmaster clock failure or degradation in transport network timing synchronization information.

Aspect 30: The method of Aspect 29, further comprising: transmitting, to a time synchronization function node, an indication of the time synchronization change.

Aspect 31: The method of Aspect 30, wherein the indication of the time synchronization change is included in a user plane node management information container (UMIC).

Aspect 32: The method of Aspect 30, wherein the indication of the time synchronization change is transmitted via a session management function node.

Aspect 33: The method of any of Aspects 30 through 32, further comprising: receiving, from the time synchronization function node, a request to subscribe to time synchronization statuses, wherein the indication of the time synchronization change is transmitted based at least in part on the request to subscribe.

Aspect 34: The method of any of Aspects 26 through 33, wherein the PTP message is for a user equipment (UE) served by the user plane function node.

Aspect 35: An apparatus for wireless communication at a device, comprising a processor; memory coupled with the processor; and instructions stored in the memory and executable by the processor to cause the apparatus to perform the method of one or more of Aspects 1-11.

Aspect 36: A device for wireless communication, comprising a memory and one or more processors coupled to the memory, the one or more processors configured to perform the method of one or more of Aspects 1-11.

Aspect 37: An apparatus for wireless communication, comprising at least one means for performing the method of one or more of Aspects 1-11.

Aspect 38: A non-transitory computer-readable medium storing code for wireless communication, the code comprising instructions executable by a processor to perform the method of one or more of Aspects 1-11.

Aspect 39: A non-transitory computer-readable medium storing a set of instructions for wireless communication, the set of instructions comprising one or more instructions that, when executed by one or more processors of a device, cause the device to perform the method of one or more of Aspects 1-11.

Aspect 40: An apparatus for wireless communication at a device, comprising a processor; memory coupled with the processor; and instructions stored in the memory and executable by the processor to cause the apparatus to perform the method of one or more of Aspects 12-16.

Aspect 41: A device for wireless communication, comprising a memory and one or more processors coupled to the memory, the one or more processors configured to perform the method of one or more of Aspects 12-16.

Aspect 42: An apparatus for wireless communication, comprising at least one means for performing the method of one or more of Aspects 12-16.

Aspect 43: A non-transitory computer-readable medium storing code for wireless communication, the code comprising instructions executable by a processor to perform the method of one or more of Aspects 12-16.

Aspect 44: A non-transitory computer-readable medium storing a set of instructions for wireless communication, the set of instructions comprising one or more instructions that, when executed by one or more processors of a device, cause the device to perform the method of one or more of Aspects 12-16.

Aspect 45: An apparatus for wireless communication at a device, comprising a processor; memory coupled with the processor; and instructions stored in the memory and executable by the processor to cause the apparatus to perform the method of one or more of Aspects 17-25.

Aspect 46: A device for wireless communication, comprising a memory and one or more processors coupled to the memory, the one or more processors configured to perform the method of one or more of Aspects 17-25.

Aspect 47: An apparatus for wireless communication, comprising at least one means for performing the method of one or more of Aspects 17-25.

Aspect 48: A non-transitory computer-readable medium storing code for wireless communication, the code comprising instructions executable by a processor to perform the method of one or more of Aspects 17-25.

Aspect 49: A non-transitory computer-readable medium storing a set of instructions for wireless communication, the set of instructions comprising one or more instructions that, when executed by one or more processors of a device, cause the device to perform the method of one or more of Aspects 17-25.

Aspect 50: An apparatus for wireless communication at a device, comprising a processor; memory coupled with the processor; and instructions stored in the memory and executable by the processor to cause the apparatus to perform the method of one or more of Aspects 26-34.

Aspect 51: A device for wireless communication, comprising a memory and one or more processors coupled to the memory, the one or more processors configured to perform the method of one or more of Aspects 26-34.

Aspect 52: An apparatus for wireless communication, comprising at least one means for performing the method of one or more of Aspects 26-34.

Aspect 53: A non-transitory computer-readable medium storing code for wireless communication, the code comprising instructions executable by a processor to perform the method of one or more of Aspects 26-34.

Aspect 54: A non-transitory computer-readable medium storing a set of instructions for wireless communication, the set of instructions comprising one or more instructions that, when executed by one or more processors of a device, cause the device to perform the method of one or more of Aspects 26-34.

The foregoing disclosure provides illustration and description but is not intended to be exhaustive or to limit the aspects to the precise forms disclosed. Modifications and variations may be made in light of the above disclosure or may be acquired from practice of the aspects.

Further disclosure is included in the appendix. The appendix is provided as an example only and is to be considered part of the specification. A definition, illustration, or other description in the appendix does not supersede or override similar information included in the detailed description or figures. Furthermore, a definition, illustration, or other description in the detailed description or figures does not supersede or override similar information included in the appendix. Furthermore, the appendix is not intended to limit the disclosure of possible aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

1. An apparatus for wireless communication at a user equipment (UE), comprising:
one or more memories; and
one or more processors, coupled to the one or more memories, configured to:
receive, from a radio access network (RAN) node, an indication that a time synchronization change has been detected; and
adjust a clock associated with the UE based at least in part on the indication.

2. The apparatus of claim 1, wherein the indication that the time synchronization change has been detected is included in a broadcast message.

3. The apparatus of claim 1, wherein the indication that the time synchronization change has been detected is included in a dedicated radio resource control (RRC) message.

4. The apparatus of claim 1, wherein the indication that the time synchronization change has been detected is included in a precision time protocol (PTP) message.

5. The apparatus of claim 1, wherein the one or more processors are further configured to:
transmit a precision time protocol (PTP) message indicating the time synchronization change.

6. The apparatus of claim 5, wherein the PTP message is transmitted by a device-side time sensitive networking (TSN) translator (DS-TT) co-located with the UE.

7. The apparatus of claim 1, wherein the one or more processors are further configured to:
receive, from a time synchronization node, a request for a time synchronization status associated with the UE; and
transmit, based at least in part on the request, an indication of the time synchronization change.

8. The apparatus of claim 7, wherein the request and the indication of the time synchronization change are included in non-access stratum (NAS) messages.

9. The apparatus of claim 8, wherein the NAS messages comprise port management information containers (PMICs).

10. The apparatus of claim 1, wherein the one or more processors are further configured to:
perform a registration update with a network associated with the RAN node, based at least in part on the indication that the time synchronization change has been detected; or
perform a location procedure with a network associated with the RAN node.

11-35. (canceled)

36. A method of wireless communication performed by a user equipment (UE), comprising:
receiving, from a radio access network (RAN) node, an indication that a time synchronization change has been detected; and
adjusting a clock associated with the UE based at least in part on the indication.

37. The method of claim 36, wherein the indication that the time synchronization change has been detected is included in a broadcast message.

38. The method of claim 36, wherein the indication that the time synchronization change has been detected is included in a dedicated radio resource control (RRC) message.

39. The method of claim 36, wherein the indication that the time synchronization change has been detected is included in a precision time protocol (PTP) message.

40. The method of claim 36, further comprising:
transmitting a precision time protocol (PTP) message indicating the time synchronization change.

41. The method of claim 40, wherein the PTP message is transmitted by a device-side time sensitive networking (TSN) translator (DS-TT) co-located with the UE.

42. The method of claim 36, further comprising:
receiving, from a time synchronization node, a request for a time synchronization status associated with the UE; and
transmitting, based at least in part on the request, an indication of the time synchronization change.

43. The method of claim 42, wherein the request and the indication of the time synchronization change are included in non-access stratum (NAS) messages.

44. The method of claim 43, wherein the NAS messages comprise port management information containers (PMICs).

45. A non-transitory computer-readable medium storing a set of instructions for wireless communication, the set of instructions comprising:
one or more instructions that, when executed by one or more processors of a user equipment (UE), cause the UE to:
receive, from a radio access network (RAN) node, an indication that a time synchronization change has been detected; and
adjust a clock associated with the UE based at least in part on the indication.
